(19) United States
(12) Patent Application Publication
(10) Pub. No.: US 2020/0272349 A1
(43) Pub. Date: Aug. 27, 2020

(54) INFORMATION PROCESSING SYSTEM AND INFORMATION PROCESSING APPARATUS

(71) Applicant: FUJITSU LIMITED, Kawasaki-shi (JP)

(72) Inventor: Kazuhito MATSUDA, Kawasaki (JP)

(73) Assignee: FUJITSU LIMITED, Kawasaki-shi, Kanagawa (JP)

(21) Appl. No.: 16/738,306

(22) Filed: Jan. 9, 2020

(30) Foreign Application Priority Data
Feb. 25, 2019 (JP) 2019-031364

(51) Int. Cl. G06F 3/06

(52) U.S. Cl. CPC G06F 3/0641; G06F 3/0673; G06F 3/0608

(57) ABSTRACT

An information-processing-system includes an information-processing-apparatus to acquire log information from a predetermined number of log-acquisition-target-apparatuses, extract a difference portion between the acquired predetermined number of log information as a variable part, replace the extracted variable part with an identifier in the log information, calculate a first hash of the replaced log information, and transmit extraction-information, the identifier, and the first hash to a log-acquisition-target-apparatus different from the predetermined number of log-acquisition-target-apparatuses, and a log-acquisition-target-apparatus to receive the extraction-information, the identifier, and the first hash, extract the variable part from the log information generated in the log-acquisition-target-apparatus, based on the extraction-information, replace the variable part of the generated log information with the identifier, calculate a second hash of the replaced log information, determine whether or not the second hash matches the first hash, transmit the first hash or the log information to the information-processing-apparatus.

### CROSS-REFERENCE TO RELATED APPLICATION

This application is based upon and claims the benefit of the prior Japanese Patent Application No. 2019-031364, filed on Feb. 25, 2019, the entire contents of which are incorporated herein by reference.

### FIELD

The embodiments discussed herein are related to an information processing system, an information processing apparatus, and a computer storage medium that stores an information processing program.

### BACKGROUND

A large amount of data is used in an information processing system. An increase of data causes an increase in capacity required for a storage device and an increase in load on a network for data communication.

Therefore, for example, in order to reduce the occupied area of a storage and a network for a main storage device and an auxiliary storage device called a backup or an archive, a method of detecting duplicate data at a sub-file level and de-duplicating the sub-file data has been proposed. In the proposed method, one or more “chunks” are created from file storage units or block storage units that are analyzed for de-duplication, and it is detected whether or not duplicate chunks have been created.

Related techniques are disclosed in, for example, International Publication Pamphlet No. WO 2010/080591.

### SUMMARY

According to an aspect of the embodiments, an information processing system includes an information processing apparatus configured to include a first memory, and a first processor coupled to the first memory and the first processor configured to acquire log information from each of a predetermined number of log acquisition target apparatuses among a plurality of log acquisition target apparatuses, each of the plurality of log acquisition target apparatuses generating the log information, extract a difference portion between the acquired predetermined number of log information as a variable part, replace the extracted variable part with an identifier in the log information, calculate a first hash value of the replaced log information, and transmit extraction information to be used for extraction of the variable part in the log information, the identifier, and the first hash value to a log acquisition target apparatus of the plurality of log acquisition target apparatuses different from the predetermined number of log acquisition target apparatuses, and a log acquisition target apparatus of the plurality of log acquisition target apparatuses configured to include a second memory, and a second processor coupled to the second memory and the second processor configured to receive the extraction information, the identifier, and the first hash value, extract the variable part from the log information generated in the log acquisition target apparatus, based on the extraction information, replace the variable part of the generated log information with the identifier, calculate a second hash value of the replaced log information, determine whether or not the second hash value matches the first hash value, transmit the first hash value to the information processing apparatus when determined that the second hash value matches the first hash value, and transmit the log information to the information processing apparatus when determined that the second hash value does not match the first hash value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating an information processing system according to a first embodiment;

FIG. 2 is a view illustrating an information processing system according to a second embodiment;

FIG. 3 is a block diagram illustrating a hardware example of a data center (DC) server;

FIG. 4 is a view illustrating an example of a process deployment and a process execution;

FIG. 5 is a view illustrating an example of a log file;

FIG. 6 is a block diagram illustrating an example of the function of the DC server;

FIG. 7 is a block diagram illustrating an example of the function of an edge computer (EC);

FIG. 8 is a view illustrating an example of a program repository entry;

FIG. 9 is view illustrating an example of a process execution history entry;

FIG. 10 is a view illustrating an example of a log data store entry;

FIG. 11 is a view illustrating an example of a variable part identification information DB entry;

FIG. 12 is a view illustrating an example of a variable part data base (DB) entry;

FIG. 13 is a view illustrating an example of response record information for each EC;

FIG. 14 is a view illustrating an example of match information;

FIG. 15 is a view illustrating an example of same hash response count information;

FIG. 16 is a view illustrating an example of a cluster DB entry;

FIG. 17 is a flowchart illustrating an example of a program deployment instruction and an execution instruction;

FIG. 18 is a flowchart illustrating an example of the program deployment and the process execution;

FIG. 19 is a view illustrating an example of the program deployment and execution;

FIG. 20 is a flowchart illustrating an example of a log file collection control;

FIG. 21 is a flowchart illustrating an example of a log acquisition (sampling);

FIG. 22 is a view illustrating an example of the log acquisition (sampling);

FIG. 23 is a flowchart illustrating an example of a variable part estimation;

FIG. 24 is a view illustrating an example of the variable part estimation;

FIG. 25 is a flowchart illustrating an example of a log acquisition (de-duplication);

FIG. 26 is a flowchart illustrating an example of a transmission process by an EC;

FIG. 27 is a view illustrating an example of the log acquisition (de-duplication);

FIG. 28 is a flowchart illustrating an example of a cluster update;

FIG. 29 is a view illustrating an example of the cluster update;

FIG. 30 is a flowchart illustrating an example of a variable value acquisition;

FIG. 31 is a flowchart illustrating an example of a variable value transmission; and

FIG. 32 is a view illustrating an example of the variable value acquisition.

### DESCRIPTION OF EMBODIMENTS

An information processing apparatus may collect the logs from a plurality of devices. In this case, there is a problem that a communication load accompanying the log collection may increase. For example, there may be a small amount of duplicate contents in the logs generated in units of apparatus that generates the logs. In addition, in certain cases, even when the chunks are detected and de-duplicated in each apparatus as described above before log transmission, the communication load accompanying the log collection by the information processing apparatus may not be reduced sufficiently.

Hereinafter, embodiments of a technique capable of reducing the communication load in log collection will be described with reference to the accompanying drawings.

### First Embodiment

A first embodiment will be described.

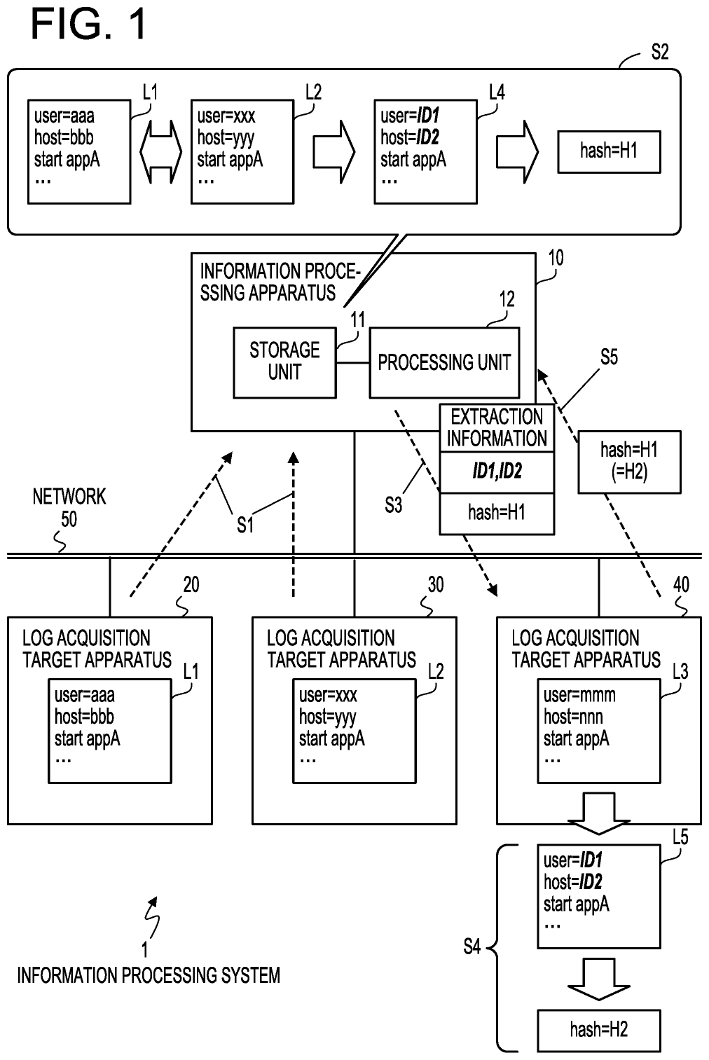

FIG. 1 is a view illustrating an information processing system according to a first embodiment.

The information processing system 1 includes an information processing apparatus 10 and log acquisition target apparatuses 20, 30, and 40. The information processing apparatus 10 and the log acquisition target apparatuses 20, 30, and 40 are connected to a network 50. The information processing system 1 may include four or more log acquisition target apparatuses. The log acquisition target apparatuses 20, 30, and 40 execute a process by a common program. Each of the log acquisition target apparatuses 20, 30, and 40 generates log information according to a process in the own apparatus by the program or a process in a device connected to the own apparatus.

The information processing apparatus 10 acquires the log information from the log acquisition target apparatuses 20, 30, and 40. The information processing apparatus 10 includes a storage unit 11 and a processing unit 12.

The storage unit 11 may be a volatile storage device such as a RAM (Random Access Memory), or a nonvolatile storage device such as an HDD (Hard Disk Drive) or a flash memory. The processing unit 12 may include a CPU (Central Processing Unit), a DSP (Digital Signal Processor), an ASIC (Application Specific Integrated Circuit), an FPGA (Field Programmable Gate Array), and the like. The processing unit 12 may be a processor that executes a program. The “processor” used herein may include a set of multiple processors (a multiprocessor). Each of the log acquisition target apparatuses 20, 30, and 40 also includes a storage unit (not illustrated) that stores the generated log information, and a processing unit (not illustrated) that controls the generation and transmission of the log information.

The storage unit 11 stores the log information collected by the processing unit 12 and information generated by the processing unit 12. Here, for example, at a certain point of time, the log acquisition target apparatus 20 generates and holds log information L1. The log acquisition target apparatus 30 generates and holds log information L2. The log acquisition target apparatus 40 generates and holds log information L3.

The processing unit 12 acquires the log information from each of a predetermined number of log acquisition target apparatuses among the plurality of log acquisition target apparatuses (operation S1). For example, the processing unit 12 acquires the log information L1 and L2 from two log acquisition target apparatuses 20 and 30 among the log acquisition target apparatuses 20, 30, and 40.

The processing unit 12 extracts a difference between the acquired predetermined numbers of log information as a variable part, replaces the extracted variable part with an identifier, and calculates a first hash value of the log information after the replacement (operation S2). For example, the processing unit 12 extracts a difference between the acquired log information L1 and L2 as a variable part. The processing unit 12 may use a command taking a difference between two texts (e.g., diff provided by a predetermined OS (Operating System), etc.).

As an example, the log information L1 includes “user=aaa” on the first line, “host=bbb” on the second line, and text information “start appA . . . ” on the third and subsequent lines. The log information L2 includes “user=xxx” on the first line, “host=yyy” on the second line, and text information “start appA . . . ” on the third and subsequent lines. The other descriptions of the log information L1 and L2 are the same.

The processing unit 12 compares the log information L1 and L2 to extract a difference portion immediately after “user=” in the log information L1 and L2 (portions different in “aaa” and “xxx”) and a difference portion immediately after “host=” in the log information L1 and L2 (portions different in “bbb” and “yyy”). The processing unit 12 sets the extracted portions as variable parts. For example, the processing unit 12 sets a difference portion immediately after “user=” on the first line of the log information L1 and L2 as a first variable part. The processing unit 12 sets a difference portion immediately after “host=” on the second line of the log information L1 and L2 as a second variable part.

The processing unit 12 replaces the extracted variable part with an identifier. For example, the processing unit 12 assigns an identifier “ID1” to the first variable part and assigns an identifier “ID2” to the second variable part. Then, the processing unit 12 replaces the difference portion immediately after “user=” in the log information L1 with “ID1” (ID is an abbreviation of “identifier”) and replaces the difference portion immediately after “host=” in the log information L1 with “ID2”. Log information L4 is log information after the replacement. Further, the processing unit 12 may obtain the log information L4 after the replacement even when the variable part of the log information L2 is replaced in the same manner.

The processing unit 12 calculates the first hash value (hash=H1) of the log information L4 by inputting the log information L4 after the replacement to a predetermined hash function. The hash function used by the processing unit 12 is also shared by the log acquisition target apparatuses 20, 30, and 40. The size of the hash value is smaller than the size of the log information input to the hash function. The hash value is sometimes called a summary value.

The processing unit 12 transmits the extraction information used for extraction of the variable part in the log information, the identifier used for the replacement, and the first hash value to log acquisition target apparatuses different from the predetermined number of log acquisition target apparatuses among the plurality of log acquisition target apparatuses (operation S3).

For example, the processing unit 12 generates the extraction information used for extraction of the variable part in the log information L1 and L2. The extraction information includes information for specifying the first variable part immediately after “user=” and the second variable part immediately after “host=” in the log information L1 and L2. The information for specifying the first variable part includes a line number (e.g., “first line”, etc.) in the log information L1 and L2, and a regular expression (e.g., “user=*”, the asterisk “*” indicating a wild card) representing a position of the corresponding variable part. Similarly, the information for specifying the second variable part includes a line number (e.g., “second line”, etc.) in the log information L1 and L2, and a regular expression (e.g., “host=*”) representing a position of the corresponding variable part. However, the contents of the extraction information are not limited thereto. Further, the contents of the extraction information may be a combination of line number and regular expression, or maybe only a regular expression when the variable part can be specified only by the regular expression.

The processing unit 12 transmits the extraction information, the identifiers “ID1” and “ID2” used for the replacement, and the first hash value (hash=H1) to the log acquisition target apparatus 40 among the log acquisition target apparatuses 20, 30, and 40. When a plurality of variable parts is included in the extraction information, an identifier may be associated with each of the variable parts. In the above example, the identifier “ID1” may be associated with the first variable part. Further, the identifier “ID2” may be associated with the second variable part. The extraction information includes information on the correspondence between the variable part and the identifier. In addition, the identifier information may be included in the extraction information.

The log acquisition target apparatus 40 receives the extraction information, the identifier, and the first hash value transmitted by the information processing apparatus 10. The log acquisition target apparatus 40 extracts a variable part from the generated log information based on the extraction information, and calculates a second hash value of the log information after replacement of the variable part of the generated log information with an identifier (operation S4).

For example, the log acquisition target apparatus 40 extracts a variable part from the generated log information L3 based on the extraction information. In an example, the log information L3 includes “user=mmm” on the first line, “host=nnn” on the second line, and text information “start appA . . . ” on the third and subsequent lines. For example, based on the regular expression “user=*” for the line number “first line” in the extraction information, the log acquisition target apparatus 40 extracts the portion “mmm” of “user=mmm” as the first variable part. Based on the extraction information, the log acquisition target apparatus 40 replaces the first variable part (corresponding to the portion “mmm”) with the identifier “ID1” corresponding to the first variable part. Similarly, based on the regular expression “host=*” for the line number “second line” in the extraction information, the log acquisition target apparatus 40 extracts the portion “nnn” of “host=nnn” as the second variable part. Based on the extraction information, the log acquisition target apparatus 40 replaces the second variable part (corresponding to the portion “nnn”) with the identifier “ID2” corresponding to the second variable part. Log information L5 is log information after the replacement with respect to the log information L3

Then, the log acquisition target apparatus 40 inputs the log information L5 to a hash function (the same hash function as the hash function used by the information processing apparatus 10), and calculates a second hash value (hash=H2) of the log information L2.

The log acquisition target apparatus 40 determines whether or not the calculated second hash value matches the first hash value. The log acquisition target apparatus 40 transmits the first hash value to the information processing apparatus 10 when it is determined that the hash values match, and transmits the generated log information to the information processing apparatus 10 when it is determined that the hash values do not match (operation S5).

For example, when the first hash value (hash=H1) and the second hash value (hash=H2) match (H1=H2), the log acquisition target apparatus 40 transmits the first hash value (hash=H1) to the information processing apparatus 10. In this case, since the first hash value is equal to the second hash value, it may be said that the log acquisition target apparatus 40 transmits the second hash value to the information processing apparatus 10.

Alternatively, when the first hash value (hash=H1) received from the information processing apparatus 10 and the second hash value (hash=H2) calculated by the log acquisition target apparatus 40 do not match (H1≠H2), the log acquisition target apparatus 40 transmits the generated log information L3 to the information processing apparatus 10.

In the example of operation S5 in FIG. 1, a case where H1=H2 is illustrated, and a case where H1≠H2 is not illustrated.

According to the information processing system 1, the information processing apparatus 10 acquires log information from each of a predetermined number of log acquisition target apparatuses 20 and 30 among a plurality of log acquisition target apparatuses that generate log information. The information processing apparatus 10 extracts a difference between the acquired predetermined numbers of log information as a variable part, replaces the extracted variable part with an identifier, and calculates a first hash value of the log information after the replacement. The information processing apparatus 10 transmits the extraction information used for extraction of the variable part in the log information, the identifier, and the first hash value to the log acquisition target apparatus 40 different from the predetermined number of log acquisition target apparatuses. The log acquisition target apparatus 40 receives the extraction information, the identifier, and the first hash value. The log acquisition target apparatus 40 extracts the variable part from the generated log information based on the extraction information, and calculates a second hash value of the log information after the replacement of the variable part of the generated log information with the identifier. The log acquisition target apparatus 40 determines whether or not the first hash value matches the second hash value. The second hash value is transmitted to the information processing apparatus when it is determined that the hash values match, and the generated log information is transmitted to the information processing apparatus when it is determined that the hash values do not match.

As a result, the collection of log information that is different only in variable parts and common to main message portions (such as process activation and operation status) may be suppressed, which allows the collection target to be narrowed to log information having different main message portions. For example, for log acquisition target apparatuses that are operating normally and have the same main log information message, the log information itself may be omitted and only a hash value may be acquired. Therefore, only log information that contains a message such as an error different from normal ones may be acquired. As described above, the hash value size is smaller than the log information size. For this reason, the amount of data transmitted to the network 50 is reduced. Further, the amount of data transmission by the log acquisition target apparatus and the amount of data reception by the information processing apparatus 10 are reduced. Thus, by making it possible to omit log collection across a plurality of log acquisition target apparatuses, the communication load in the log collection may be reduced.

In addition, the information processing apparatus 10 may determine that, for the log acquisition target apparatus 40 that has transmitted a hash value, only variable parts of log information held by the log acquisition target apparatus 40 differ from each other and the other portions are common to the log information L1 and L2.

Further, the information processing apparatus 10 may acquire information on the variable part of the log information L3 generated by the log acquisition target apparatus 40 when the log acquisition target apparatus 40 responds with a hash value. Specifically, the information processing apparatus 10 transmits an identifier (“ID1” or “ID2”) corresponding to the variable part to the log acquisition target apparatus 40 that has responded with the first hash value and has not acquired the value of the variable part included in the log information L3. Upon receiving the identifier, the log acquisition target apparatus 40 transmits a value (“mmm” or “nnn”) described in the variable part corresponding to the identifier in the generated log information L3 to the information processing apparatus 10. Upon receiving the value, the information processing apparatus 10 may acquire the log information L3 by substituting the corresponding value “mmm” or “nnn” into the “ID1” or “ID2” portion of the log information L4. In this case, it is sufficient to transmit data having a smaller size than when the entire log information L3 is transmitted to the information processing apparatus 10, thereby the communication load is reduced.

A computer or the like having the function of “log acquisition target apparatus” may also be called “information processing apparatus”.

Hereinafter, the functions of the information processing apparatus 10 and the log acquisition target apparatuses 20, 30, and 40 will be described in more detail by illustrating a more specific information processing system.

### Second Embodiment

Next, a second embodiment will be described.

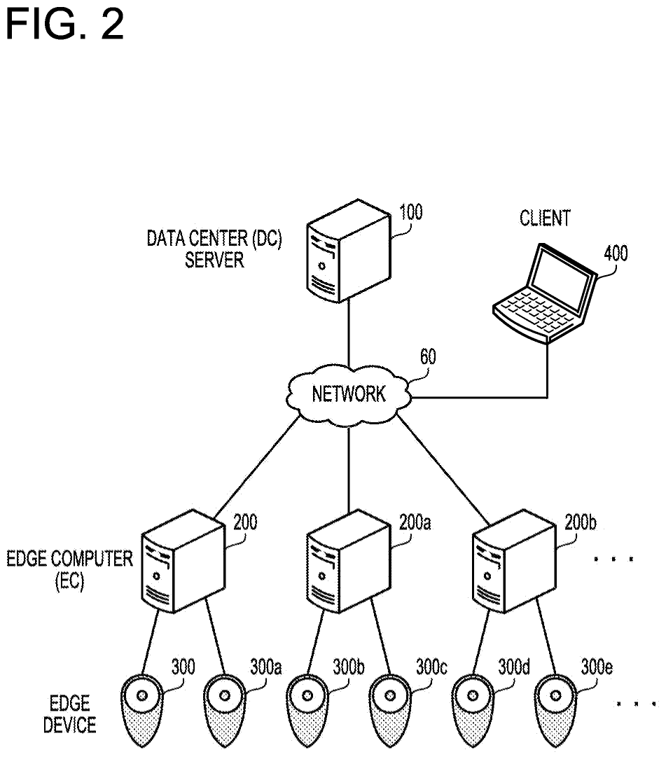

FIG. 2 is a view illustrating an example of an information processing system according to a second embodiment.

The information processing system according to the second embodiment includes a data center (DC) server 100 and edge computers (ECs) 200, 200a, 200b, . . . . The DC server 100 and the ECs 200, 200a, 200b, . . . are connected to a network 60. The network 60 may be a LAN (Local Area Network), a WAN (Wide Area Network), the Internet, or the like.

Edge devices 300 and 300a are connected to the EC 200. Edge devices 300b and 300c are connected to the EC 200a. Edge devices 300d and 300e are connected to the EC 200b. Further, a client information processing apparatus (hereinafter, referred to as a client) 400 is connected to the network 60.

Here, as an example, the information processing system according to the second embodiment provides a FaaS (Function as a Service). The system that provides the FaS receives a program (Function) written by a user, executes the program in response to a predetermined trigger such as data registration, and outputs a result.

The DC server 100 is a server computer that controls a process execution by the FaaS, and is placed in the data center. The DC server 100 distributes the program registered by the user to the ECs 200, 200a, 200b, . . . via the network 60, instructs execution according to a trigger, and collects results of the execution. As the process executed by the program, for example, a process by an edge device connected to an edge computer or a process by the edge computer may be considered. The DC server 100 collects logs of the ECs 200, 200a, 200b, . . . , and monitors the execution status of the program (e.g., whether or not the program is normally operated) by the ECs 200, 200a, 200b, . . . , based on the collected logs. The DC server 100 is an example of the information processing apparatus 10 according to the first embodiment.

The ECs 200, 200a, 200b, . . . are server computers that acquire an execution target program from the DC server 100 and execute the program according to an execution instruction from the DC server 100. The ECs 200, 200a, 200b, . . . generate and hold a log including the execution result of the program. The ECs 200, 200a, 200b, . . . provide the log to the DC server 100 in response to a request from the DC server 100. The ECs 200, 200a, 200b, . . . are examples of the log acquisition target apparatuses 20, 30, and 40 according to the first embodiment.

The edge devices 300, 300a, 300b, 300c, 300d, 300e, . . . are installed, for example, in different regions and are controlled by the ECs to which the corresponding edge devices are connected. As for the edge devices 300, 300a, 300b, 300c, 300d, 300e, . . . , various devices such as sensors for measuring physical quantities such as temperature and precipitation, cameras for imaging the surroundings, air conditioners, robots, and the like may be considered.

The client 400 is a client computer operated by a user who uses the information processing system according to the second embodiment. The client 400 inputs, to the DC server 100, via the network 60, an instruction to deploy an execution target program, information about a trigger for executing the program, a result of the execution, an instruction to acquire a log, and the like.

As described above, a method in which edge devices and ECs are placed in the vicinity (edge) of the observation/measurement target and the data of the edge devices is aggregated and processed by the ECs and transmitted to the DC server 100 may be called an edge computing.

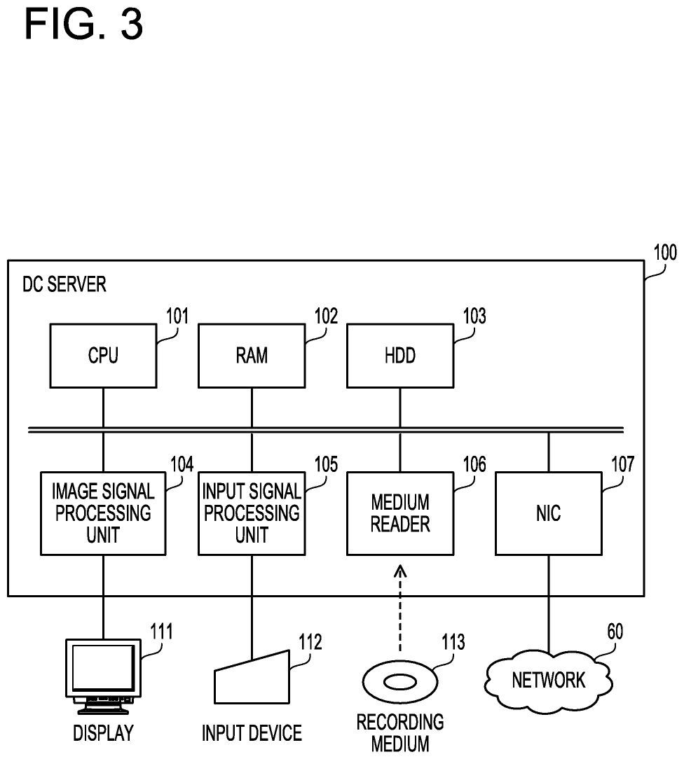

FIG. 3 is a block diagram illustrating a hardware example of the DC server. The DC server 100 includes a CPU 101, a RAM 102, an HDD 103, an image signal processing unit 104, an input signal processing unit 105, a medium reader 106, and an NIC (Network Interface Card) 107. The CPU 101 corresponds to the processing unit 12 of the first embodiment. The RAM 102 or the HDD 103 corresponds to the storage unit 11 of the first embodiment.

The CPU 101 is a processor that executes a program instruction. The CPU 101 loads at least a portion of the program and data stored in the HDD 103 into the RAM 102 and executes the program. Further, the CPU 101 may include a plurality of processor cores. The DC server 100 may have a plurality of processors. The processes to be described below may be executed in parallel using the plurality of processors or processor cores. A set of processors may be referred to as a “multiprocessor” or simply a “processor”.

The RAM 102 is a volatile semiconductor memory that temporarily stores programs executed by the CPU 101 and data used by the CPU 101 for calculation. The DC server 100 may include a type of memory other than the RAM, or may include a plurality of memories.

The HDD 103 is a nonvolatile storage device that stores software programs such as an OS, middleware and application software, and data. The DC server 100 may include other types of storage devices such as a flash memory and an SSD (Solid State Drive), and may include a plurality of nonvolatile storage devices.

The image signal processing unit 104 outputs an image to a display 111 connected to the DC server 100 according to a command from the CPU 101. As for the display 111, any type of display such as a CRT (Cathode Ray Tube) display, a liquid crystal display (LCD), a plasma display, an organic electro-luminescence (OEL) display, or the like may be used.

The input signal processing unit 105 acquires an input signal from an input device 112 connected to the DC server 100 and outputs the acquired input signal to the CPU 101. As for the input device 112, a pointing device such as a mouse, a touch panel, a touch pad, a trackball, or the like, a keyboard, a remote controller, a button switch, or the like may be used. A plurality of types of input devices may be connected to the DC server 100.

The medium reader 106 is a reading device that reads out a program and data recorded on the recording medium 113. As for the recording medium 113, for example, a magnetic disk, an optical disk, a magneto-optical disk (MO), a semiconductor memory, or the like may be used. The magnetic disk includes a flexible disk (FD) and an HDD. The optical disk includes a CD (Compact Disc) and a DVD (Digital Versatile Disc).

The medium reader 106 copies, for example, the program and data read from the recording medium 113 onto another recording medium such as the RAM 102 or the HDD 103. The read program is executed by, for example, the CPU 101. The recording medium 113 may be a portable recording medium and may be used to distribute the program and data. The recording medium 113 and the HDD 103 may be referred to as a computer-readable recording medium.

The NIC 107 is an interface that is connected to the network 60 and communicates with other computers via the network 60. The NIC 107 is connected, for example, by a cable to a communication device such as a switch or a router.

The ECs 200, 200a, 200b, . . . and the client 400 are also implemented by the same hardware as the DC server 100.

In addition, the edge devices 300, 300a, 300b, 300c, 300d, 300e, . . . each have a processor such as a CPU, a main storage device such as a RAM, and an auxiliary storage device such as a flash memory (not illustrated).

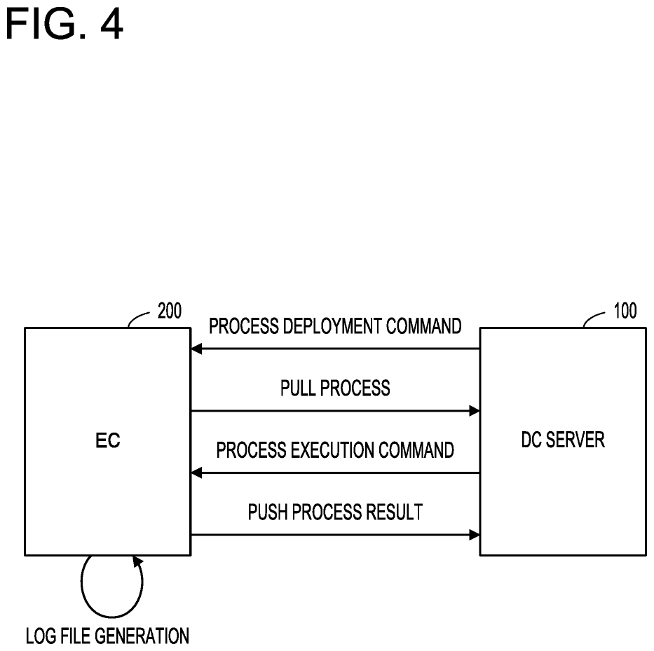

FIG. 4 is a view illustrating an example of a process deploy and a process execution.

In FIG. 4, the description will be focused on the EC 200, but may be equally applied to the EC 200a, 200b, . . . .

First, the DC server 100 transmits, to the EC 200, a process deploy command related to a program uploaded by the client 400, in response to a deploy instruction from the client 400. The process deploy command includes a process identifier as an argument and instructs the EC 200 to deploy the program. The EC 200 acquires (pulls) the program from the DC server 100 using the identifier included in the process deploy command.

Next, when detecting a predetermined trigger, the DC server 100 transmits a process execution command to the EC 200 using an identifier of a deployed process corresponding to the trigger as an argument. The EC 200 executes a program corresponding to the identifier included in the process execution command and transmits (pushes) a result of the process of the program to the DC server 100. Alternatively, the EC 200 may perform an operation control of the edge devices 300 and 300a (e.g., operation of an actuator, etc.) according to execution of the program.

The EC 200 generates a log file describing the contents of log according to the execution of the program, separately from the processing result and the operation of the actuator. The log file is checked by the DC server 100 for debugging during system development by a user or for checking a normal operation. However, when the DC server 100 collects log files from all ECs, there is a possibility of an excessive communication load accompanying the log file collection. Therefore, the DC server 100 and the EC 200 provide a function that makes the log file collection more efficient.

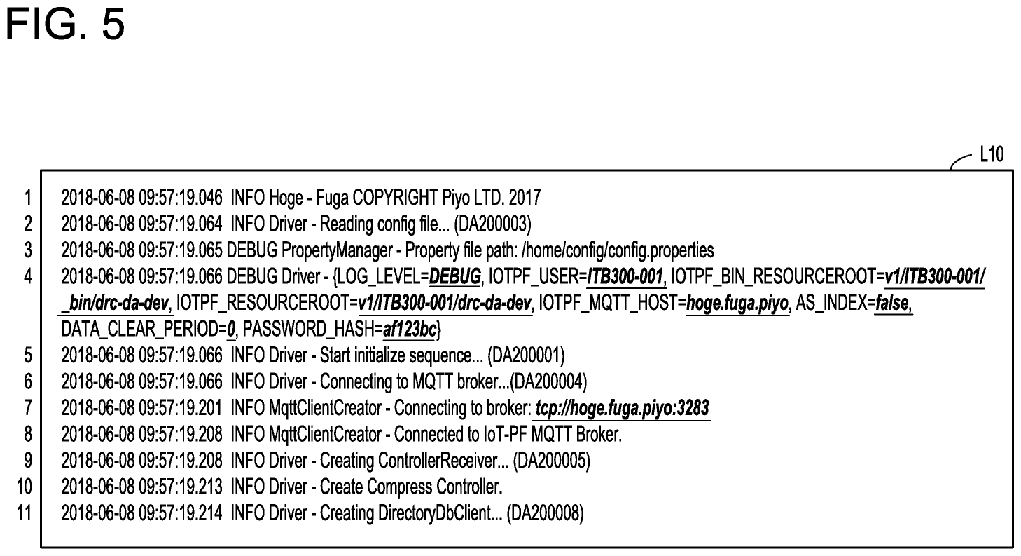

FIG. 5 is a view illustrating an example of a log file.

The log file L10 is generated by the EC 200. As described above, the execution contents of the process by the program distributed to the ECs 200, 200a, 200b, . . . are common to the ECs. That is, the DC server 100 causes a plurality of ECs to execute a common program. Each of the ECs generates a log file according to the execution of the common program.

In the log file generated by each EC according to the execution of the common program in this manner, variable parts in the log file have different values due to a difference in the environment in which each EC operates, but other messages are common.

For example, in the log file L10, the underlined portions (illustrated in italics) are the variable parts. Specifically, the portions of “DEBUG”, “ITB300-001”, “v1/ITB300-001/_bin/drc-da-dev”, “v1/ITB300-001/drc-da-dev”, “hoge.fuga.piyo”, “false”, “0”, and “af123bc” on the fourth line and the portion of “tcp://hoge.fuga.piyo: 3283” on the seventh line are the variable parts. In checking of the operation of the EC 200 using the log file L10, other message portions are more important than the description of these variable parts.

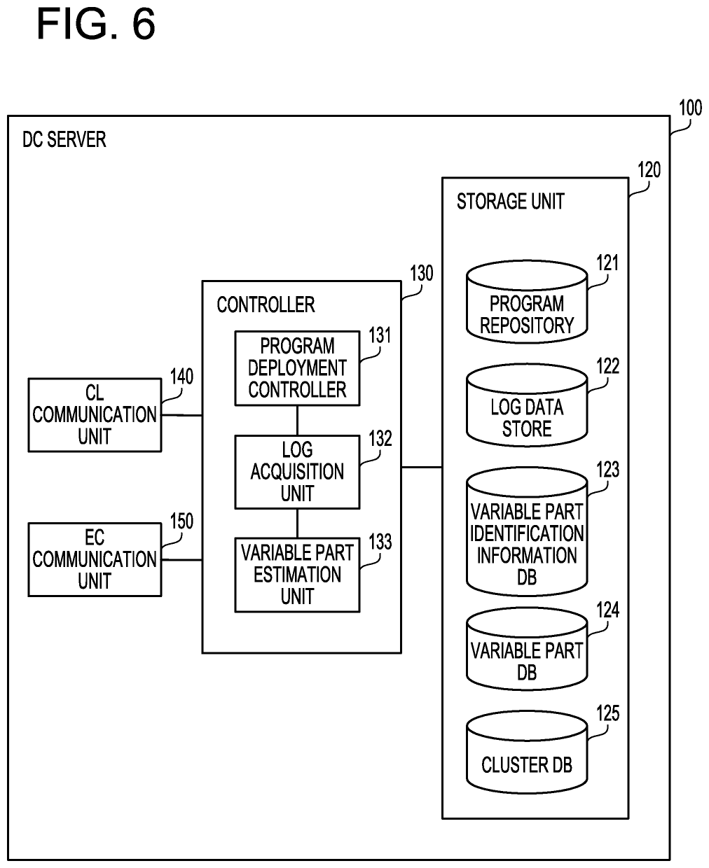

FIG. 6 is a block diagram illustrating an example of the function of the DC server.

The DC server 100 includes a storage unit 120, a controller 130, a client (CL) communication unit 140, and an EC communication unit 150. The storage unit 120 is implemented using a storage area of the RAM 102 or the HDD 103. The controller 130, the CL communication unit 140, and the EC communication unit 150 are implemented by the CPU 101 executing a program stored in the RAM 102.

The storage unit 120 stores various types of information used for a process of the controller 130. The storage unit 120 includes a program repository 121, a log data store 122, a variable part identification information database (DB) 123, a variable part DB 124, and a cluster DB 125.

The program repository 121 stores a program deployed in each EC. The program stored in the program repository 121 is created by, for example, a user and uploaded to the DC server 100 by the client 400.

The log data store 122 stores a log file collected from each EC.

The variable part identification information DB 123 stores information to be used for extraction of the variable part in the log file collected from each EC.

The variable part DB 124 stores the value of each variable part in the log file.

The cluster DB 125 stores information indicating an EC cluster. The EC cluster is a group of EC groups having the common description contents other than the value of a certain variable part in a log file. The value of the variable part may vary depending on the EC usage environment, hardware environment, and the like. For this reason, it is estimated that EC groups that belong to the same cluster have the same (or similar) usage environment or hardware environment.

The controller 130 controls a program deployment and a log file collection. The controller 130 includes a program deployment controller 131, a log acquisition unit 132, and a variable part estimation unit 133.

The program deployment controller 131 controls the program deployment for each EC and the program execution instruction according to a trigger.

The log acquisition unit 132 acquires a log file generated by each EC and stores the acquired log file in the log data store 122. First, the log acquisition unit 132 samples log files from two or more ECs and causes the variable part estimation unit 133 to execute a variable part estimation. The log acquisition unit 132 replaces the variable part of the log file with an identifier of the variable part to obtain a hash value, and provides the obtained hash value to the EC. When a hash value calculated by replacing the corresponding variable part of the log file with an identifier is different from the provided hash value, the log acquisition unit 132 acquires the log file from the EC. Meanwhile, when the hash value calculated by the EC matches the provided hash value, the log acquisition unit 132 acquires the hash value from the EC. When acquiring the value of the variable part from the EC that has transmitted the hash value, the log acquisition unit 132 designates the identifier of the variable part for an EC and causes the EC to respond with the value of the corresponding variable part. The log acquisition unit 132 stores the acquired value of the variable part in the variable part DB 124.

In addition, the log acquisition unit 132 generates or updates the information indicating the EC cluster based on a response status of the hash value from each EC, and stores the generated or updated information in the cluster DB 125.

The variable part estimation unit 133 specifies a difference portion by taking a difference (diff) between two or more sampled log files, and extracts the difference portion as a variable part. The variable part estimation part 133 generates extraction information for extracting a variable part among the log files, and stores the extraction information in the variable part identification information DB 123. In addition, when taking the difference between the log files, the variable part estimation unit 133 takes a difference after replacing a time described portion in the log file with a predetermined character string. Usually, since the time is often described in a predetermined format at a predetermined position in the line of the log file, the variable part estimation unit 133 may specify the time described portion by searching the corresponding position and the format portion in the log file.

The CL communication unit 140 communicates with the client 400. The CL communication unit 140 receives data from the client 400 and transmits data to the client 400.

The EC communication unit 150 communicates with each EC. The EC communication unit 150 transmits data to each EC and receives data from each EC.

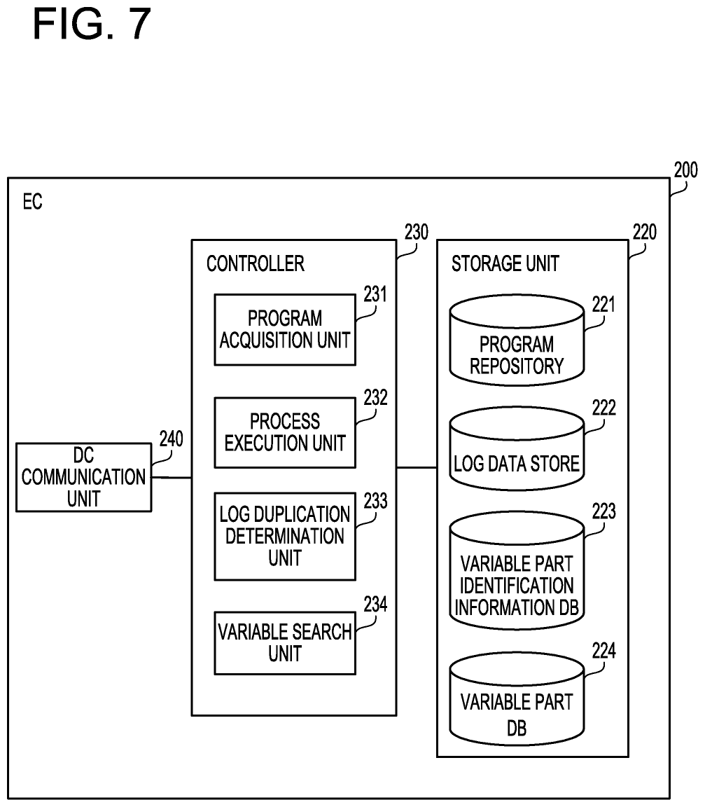

FIG. 7 is a block diagram illustrating an example of the function of an EC.

The EC 200 includes a storage unit 220, a controller 230, and a DC communication unit 240. The storage unit 220 is implemented using a storage area of a RAM or an HDD included in the EC 200. The controller 230 and the DC communication unit 240 are implemented by a CPU included in the EC 200 when the CPU executes a program stored in the RAM of the EC 200.

The storage unit 220 stores various types of information to be used for a process of the controller 230. The storage unit 220 includes a program repository 221, a log data store 222, a variable part identification information DB 223, and a variable part DB 224.

The program repository 221 stores a program acquired from the DC server 100.

The log data store 222 stores a log file generated according to execution of the program.

The variable part identification information DB 223 stores extraction information to be used for extraction of a variable part in the generated log file. The extraction information is acquired from the DC server 100.

The variable part DB 224 stores the value of each variable part in the log file.

The controller 230 controls the execution of the program and log transmission to the DC server 100. The controller 230 includes a program acquisition unit 231, a process execution unit 232, a log duplication determination unit 233, and a variable search unit 234.

The program acquisition unit 231 acquires a deployment target program from the DC server 100 and stores the acquired program in the program repository 221.

The process execution unit 232 executes a deployed program. For example, when receiving a process execution command from the DC server 100, the process execution unit 232 executes the program to generate a log file corresponding to the execution of the program. The process execution unit 232 stores the generated log file in the log data store 222.

The log duplication determination unit 233 performs a log duplication determination. Specifically, the log duplication determination unit 233 acquires, from the DC server 100, the information to be used for extraction of the variable part in the log file, an identifier for the variable part, and a hash value generated for the log file. The log duplication determination unit 233 replaces the corresponding variable part of the log file generated by the EC 200 with the acquired identifier and calculates a hash value of the log file after the replacement. At this time, the log duplication determination unit 233 stores the value of the corresponding variable part in the variable part DB 224. When both the acquired hash value and the calculated hash value match, the log duplication determination unit 233 determines that the log file generated in the EC 200 overlaps with the log file acquired by the DC server 100, and transmits the calculated hash value to the DC server 100. When the acquired hash value and the calculated hash value do not match, the log duplication determination unit 233 determines that the log file generated in the EC 200 does not overlap with the log file acquired by the DC server 100, and transmits the log file generated in the EC 200 to the DC server 100.

When the identifier of the variable part is designated from the DC server 100, the variable search unit 234 acquires the value of a variable part corresponding to the identifier from the variable part DB 224 and provides the acquired value to the DC server 100.

The DC communication unit 240 communicates with the DC server 100. The DC communication unit 240 receives data from the DC server 100 and transmits data to the DC server 100.

The EC 200a, 200b, . . . have the same function as the EC 200.

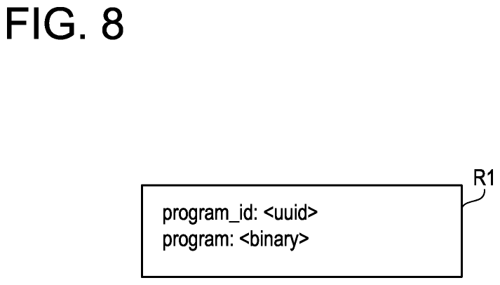

FIG. 8 is a view illustrating an example of a program repository entry.

The program repository entry R1 is data (entries) stored in the program repositories 121 and 221. The program repository entry R1 includes a “program_id” field and a “program” field.

A program identifier (uuid: Universally Unique ID) is registered in the “program_id” field.

A program body (binary data) is registered in the “program” field.

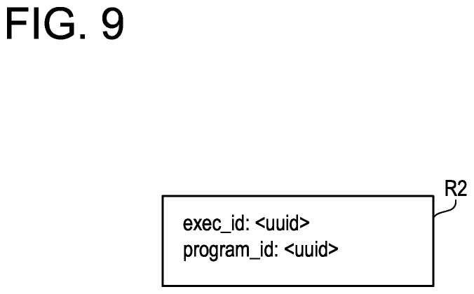

FIG. 9 is a view illustrating an example of a process execution history entry.

The process execution history entry R2 is data stored in the log data stores 122 and 222. The process execution history entry R2 includes an “exec_id” field and a “program_id” field.

A process execution identifier is registered in the “exec_id” field.

A program identifier is registered in the “program_id” field.

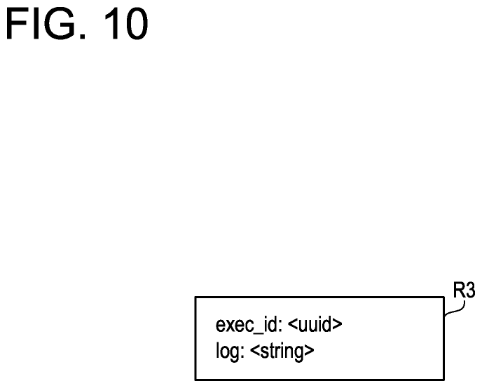

FIG. 10 is a view illustrating an example of a log data store entry.

The log data store entry R3 is data stored in the log data stores 122 and 222. The log data store entry R3 includes an “exec_id” field and a “log” field.

A process execution identifier is registered in the “exec_id” field. String data indicating the contents of a log is registered in the “log” field.

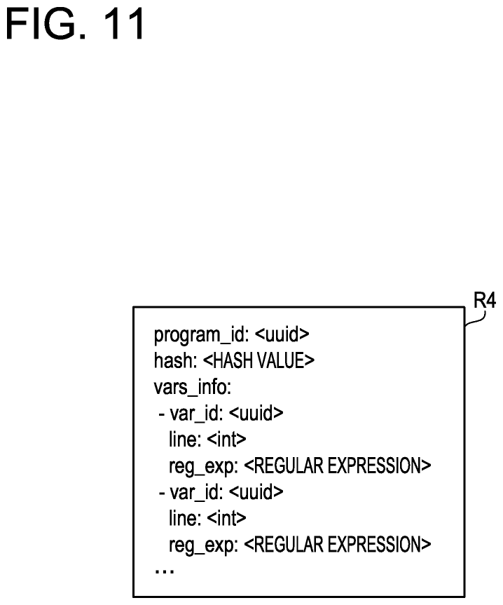

FIG. 11 is a view illustrating an example of a variable part identification information DB entry.

The variable part identification information DB entry R4 is data stored in the variable part identification information DBs 123 and 223. The variable part identification information DB entry R4 includes a “program_id” field, a “hash” field, and a “vars_info” field.

A program identifier is registered in the “program_id” field.

A hash value generated for a log file corresponding to the execution of the corresponding program (a log file after the variable part is replaced with the identifier of the variable part) is registered in the “hash” field.

Extraction information to be used for extraction of the corresponding variable part is registered in the “vars_info” field in association with the identifier of the variable part. The “vars_info” field includes a “var_id” field, a “line” field, and a “reg_exp” field.

An identifier (uuid) of the variable part is registered in the “var_id” field.

A line number at which the corresponding variable part appears in the log file of the corresponding program is registered in the “line” field.

A regular expression representing a variable part of a line indicated by the corresponding line number is registered in the “reg_exp” field.

A set of “var_id, ” “line” and “reg_exp” is registered for the number of variable parts in the “vars_info” field.

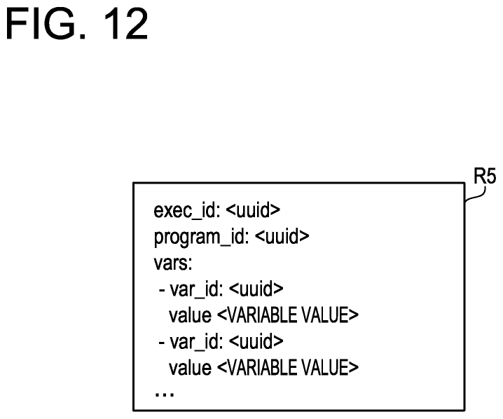

FIG. 12 is a view illustrating an example of a variable part DB entry.

The variable part DB entry R5 is data stored in the variable part DBs 124 and 224. The variable part DB entry R5 includes an “exec_id” field, a “program_id” field, and a “vars” field.

A program process execution identifier is registered in the “exec_id” field.

A program identifier is registered in the “program_id” field.

A value of the corresponding variable part is registered in the “vars” field in association with the identifier of the variable part. The “vars” field includes a “var_id” field and a “value” field.

A variable part identifier is registered in the “var_id” field.

A variable part value (variable value) is registered in the “value” field.

A set of “var_id” and value is registered for the number of variable parts in the “vars” field.

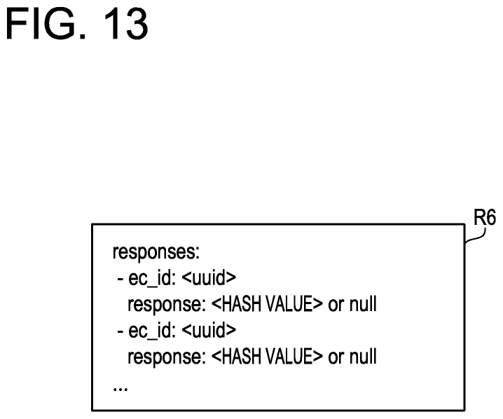

FIG. 13 is a view illustrating an example of response record information for each EC.

The EC response record information R6 is data stored in a predetermined storage area of the storage unit 120. The EC response recording information R6 is information for managing a hash value (“null” when a log file is transmitted instead of a hash value) transmitted by each EC at the time of log file collection at a certain timing. The EC response record information R6 includes a “responses” field. The “responses” field includes an “ec_id” field and a “response” field.

An EC identifier is registered in the “ec_id” field.

A hash value with which the corresponding EC responds or a “null” is registered in the “response” field. The “null” indicates that the corresponding EC responds with a log file body instead of a hash value.

A response is registered for each “ec_id” in the “responses” field.

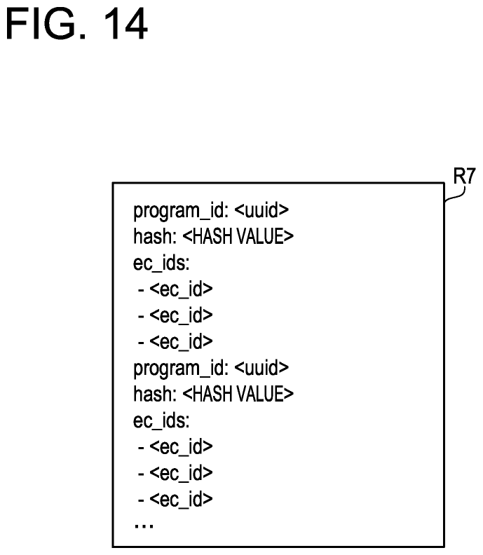

FIG. 14 is a view illustrating an example of match information.

Match information R7 is data stored in a predetermined storage area of the storage unit 120. The match information R7 is used for management of ECs that respond with the same hash value at the time of log file collection at a certain timing. The match information R7 includes a “program_id” field, a “hash” field, and an “ec_ids” field.

A program identifier is registered in the “program_id” field.

A hash value is registered in the “hash” field.

The identifier (“ec_id”) of an EC that responds with the corresponding hash value is registered in the “ec_ids” field. When there is a plurality of ECs that responds with the corresponding hash value, a plurality of “ec_ids” is registered in the “ec_ids” field.

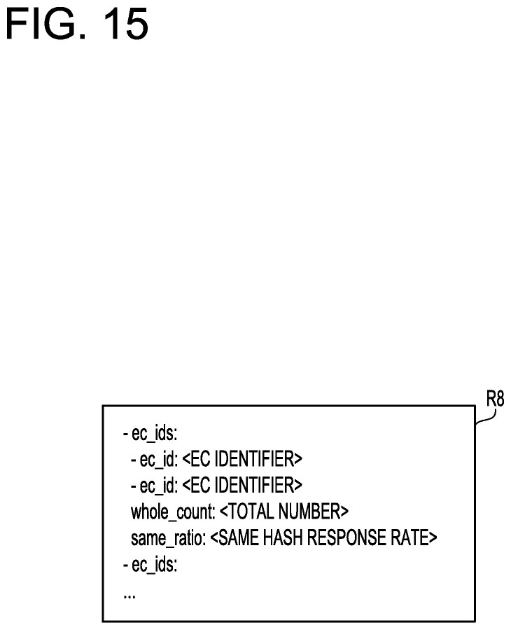

The “hash” and “ec_ids” are registered for each “program_id” in the match information R7. FIG. 15 is a view illustrating an example of same hash response count information.

The same hash response count information R8 is data stored in a predetermined storage area of the storage unit 120. The same hash response count information R8 is information for managing the number of responses of the same hash value by two or more ECs that respond with the same hash value. The same hash response count information R8 includes an “ec_ids” field, a “whole_count” field, and a “same_ratio” field.

A set of identifiers (“ec_id”) of ECs that responds with the same hash value is registered in the “ec_ids” field.

The total number of times that the corresponding two or more ECs respond with the same hash value is registered in the “whole_count” field.

A probability (same hash response rate) that two or more corresponding ECs respond with the same hash value is registered in the “same_ratio” field. The same hash response rate may be obtained by dividing “whole_count” by the total number of log acquisition requests by de-duplication transmitted to the ECs.

The “ec_ids” (“ec_id” set, “whole_count, ” and “same_ratio”) is registered for each set of ECs that responds with the same hash value in the hash response count information R8. For a set of ECs not registered in the same hash response count information R8, there is no record of responding with the same hash value (i.e., the same hash response rate is 0%).

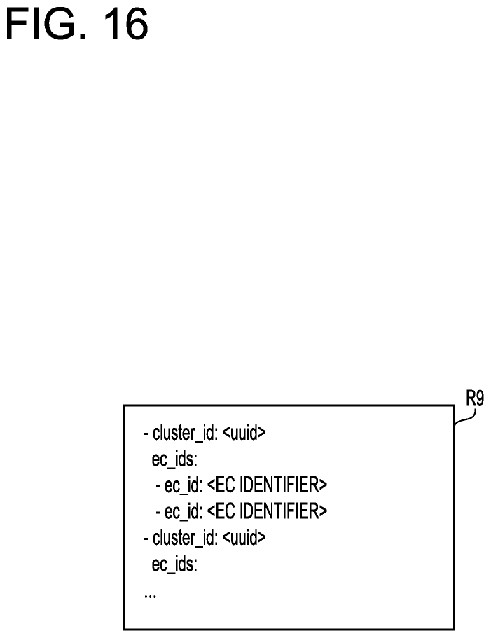

FIG. 16 is a view illustrating an example of a cluster DB entry.

The cluster DB entry R9 is data stored in the cluster DB 125. The cluster DB entry R9 includes a “cluster_id” field and an “ec_ids” field.

A cluster identifier (uuid) is registered in the “cluster_id” field.

A set of EC identifiers (“ec_id”) that belongs to the corresponding cluster is registered in the “ec_ids” field.

A set of “cluster_id” and “ec_ids” is registered for the number of created clusters in the cluster DB entry R9.

Next, a processing procedure in the information processing system according to the second embodiment will be described.

First, the procedure of a program deployment instruction and a program execution instruction by the DC server 100 will be described.

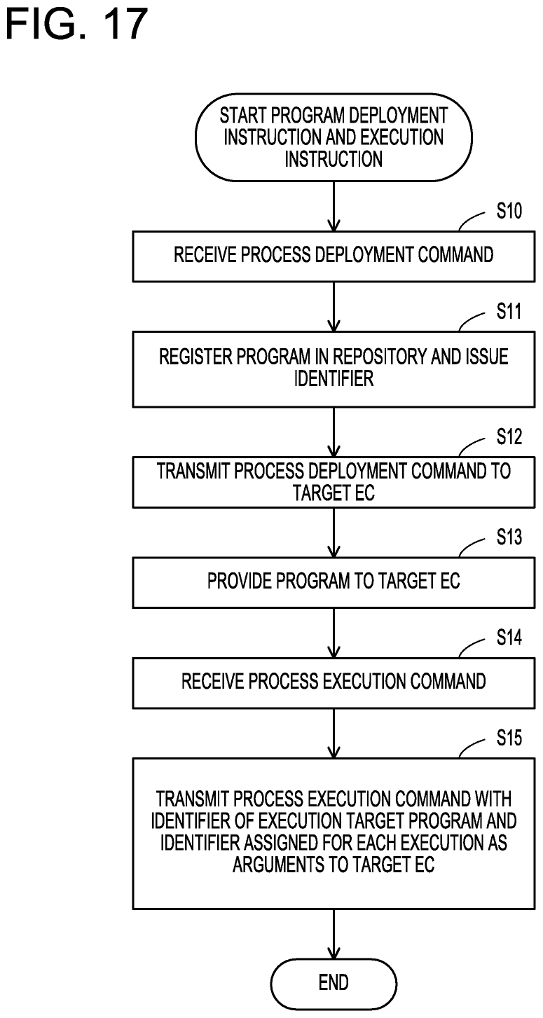

FIG. 17 is a flowchart illustrating an example of the program deployment instruction and the execution instruction.

(S10) The program deployment controller 131 receives a process deployment command from the client 400. The process deployment instruction includes designation of a deployment target program, and information on a trigger for executing the program.

(S11) The program deployment controller 131 registers the deployment target program in the program repository 121 and issues an identifier (“program_id”) for the deployment target program. As a result, the program repository entry R1 is registered in the program repository 121 for the corresponding program.

(S12) The program deployment controller 131 transmits a process deployment command to an EC targeted for program deployment (a target EC). The process deployment instruction includes a program identifier.

(S13) The program deployment controller 131 provides a deployment target program to the target EC in response to a deployment target program acquisition request from the target EC. The program deployment controller 131 stores, in the storage unit 120, information indicating a correspondence between the program identifier and the identifier (“ec_id”) of the target EC that provides the program.

(S14) The program deployment controller 131 receives a process execution command for a deployed program from the client 400.

(S15) Upon detecting the occurrence of a trigger related to the deployed program, the program deployment controller 131 transmits, to the target EC, a process execution command with the identifier of the execution target program and the process execution identifier (“exec_id”) assigned for each process execution as arguments. Thereafter, the program deployment controller 131 transmits the process execution command to the target EC each time a trigger is detected. The program deployment controller 131 stores the identifier of the execution target program and the process execution identifier in the storage unit 120 in association.

Next, the procedure for program deployment and process execution by the EC 200 will be described. In the following, the procedure of the EC 200 will be mainly described, but may be equally applied to the EC 200a, 200b, . . . .

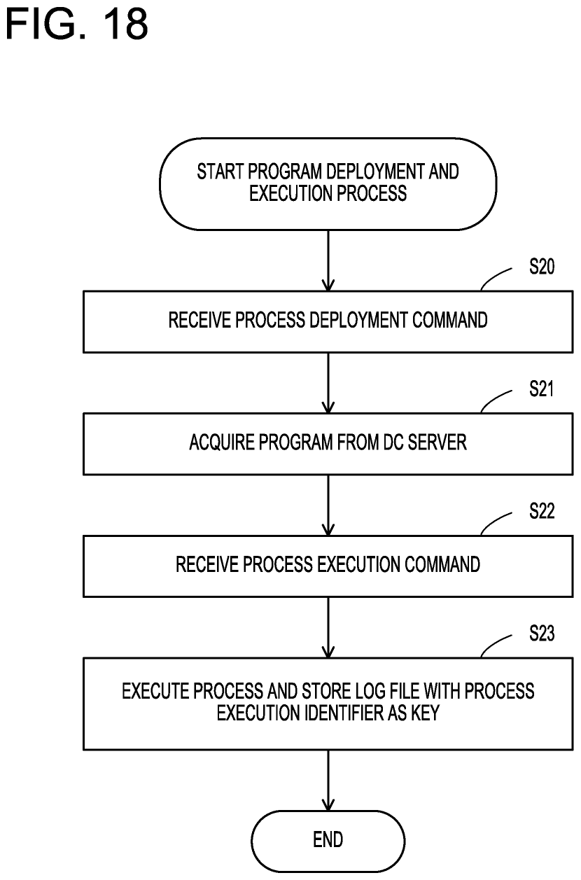

FIG. 18 is a flowchart illustrating an example of a program deployment and a process execution.

(S20) The program acquisition unit 231 receives a process deployment command from the DC server 100.

(S21) The program acquisition unit 231 transmits, to the DC server 100, a program acquisition request designating the identifier of a program included in the process deployment instruction, and acquires a program corresponding to the acquisition request from the DC server 100. The program acquisition unit 231 stores the program repository entry R1 related to the acquired program in the program repository 221.

(S22) The process execution unit 232 receives a process execution command from the DC server 100.

(S23) The process execution unit 232 executes a program process according to the process execution command and stores, in the log data store 222, a log file generated according to the process execution command using a process execution identifier (“exec_id”) included in the process execution command as a key. That is, the process execution unit 232 generates a process execution history entry R2 and a log data store entry R3 according to the program process execution and stores the generated entries in the log data store 222. Thereafter, each time a process execution command is received from the DC server 100, the process execution unit 232 stores the generated log file in the log data store 222.

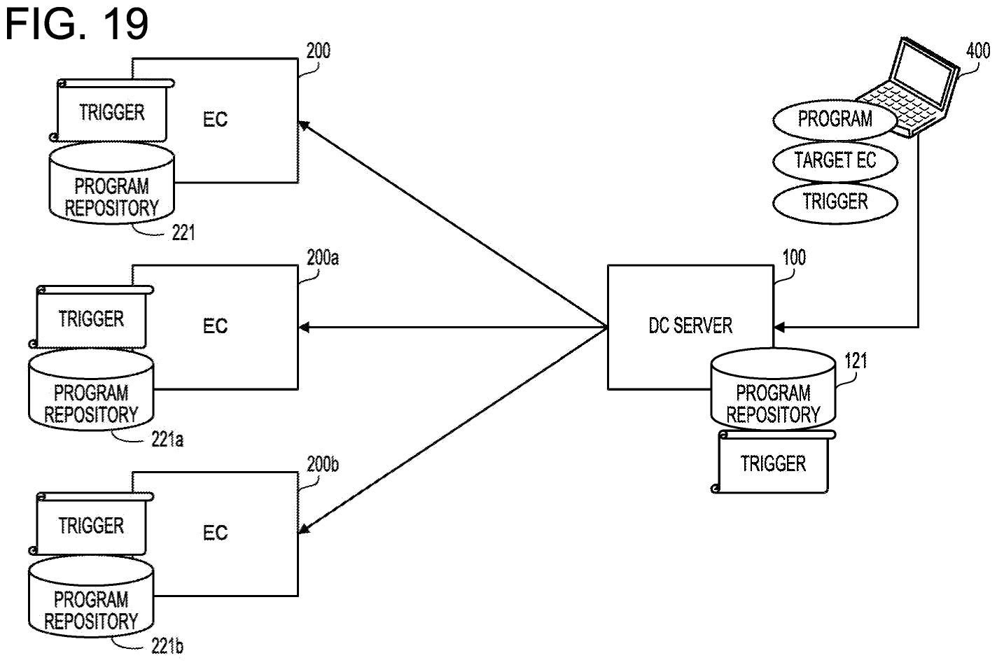

FIG. 19 is a view illustrating an example of a program deployment and execution.

The DC server 100 receives a deployment target program, information about a deployment destination EC (target EC), and information about a trigger of process execution from the client 400. The DC server 100 stores the deployment target program and the trigger information in the storage unit 120. The deployment target program is stored in the program repository 121. For example, the DC server 100 transmits a process deployment command to the ECs 200, 200a, and 200b designated as the target ECs and receives a program acquisition request corresponding to the process deployment command from the ECs 200, 200a, and 200b. The DC server 100 provides the deployment target program to the ECs 200, 200a, and 200b in response to the program acquisition request. The provided program is stored in the program repository 221 of the EC 200, the program repository 221a of the EC 200a, and the program repository 221b of the EC 200b.

When the trigger designated by the client 400 is established, the DC server 100 transmits a process execution command by the provided program to the ECs 200, 200a, and 200b. The ECs 200, 200a, and 200b generate a log file by executing a process by the corresponding program in response to the process execution command.

Next, the procedure of log file collection control by the DC server 100 will be described.

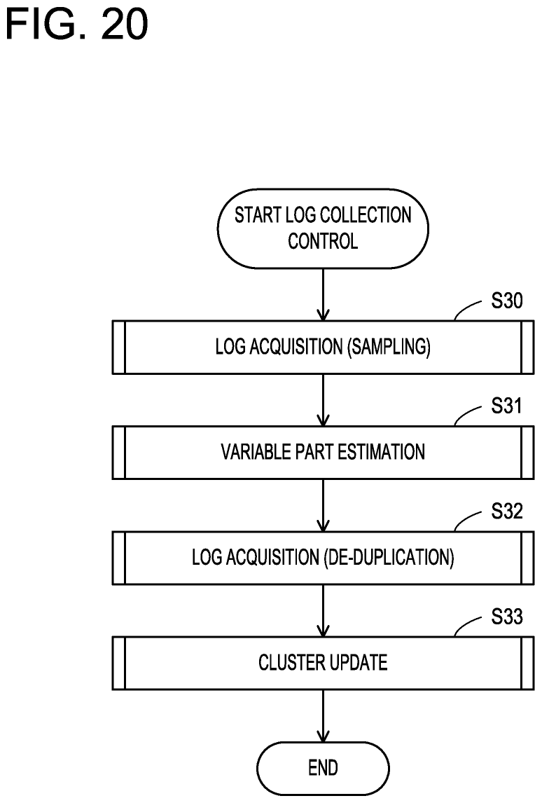

FIG. 20 is a flowchart illustrating an example of a log file collection control.

(S30) The log acquisition unit 132 executes a log acquisition by sampling. The log acquisition by sampling is to acquire a log file from a part of all ECs as certain program deployment destinations. The sampling number is 2 or more and is preset in the storage unit 120. Details of the log acquisition by sampling (sometimes referred to as “log acquisition (sampling)” will be described later.

(S31) The variable part estimation unit 133 estimates a variable part in the log file by comparing the sampled log files. Details of the variable part estimation will be described later.

(S32) The log acquisition unit 132 executes the log acquisition by de-duplication. The log acquisition by de-duplication indicates that collection of log files having only different variable parts from each EC is suppressed, and that collection is limited to log files that are different except for the variable parts. Details of the log acquisition by de-duplication (sometimes referred to as “log acquisition (de-duplication)”) will be described later.

(S33) The log acquisition unit 132 performs a cluster update according to a result of the log acquisition by de-duplication. Details of the cluster update will be described later.

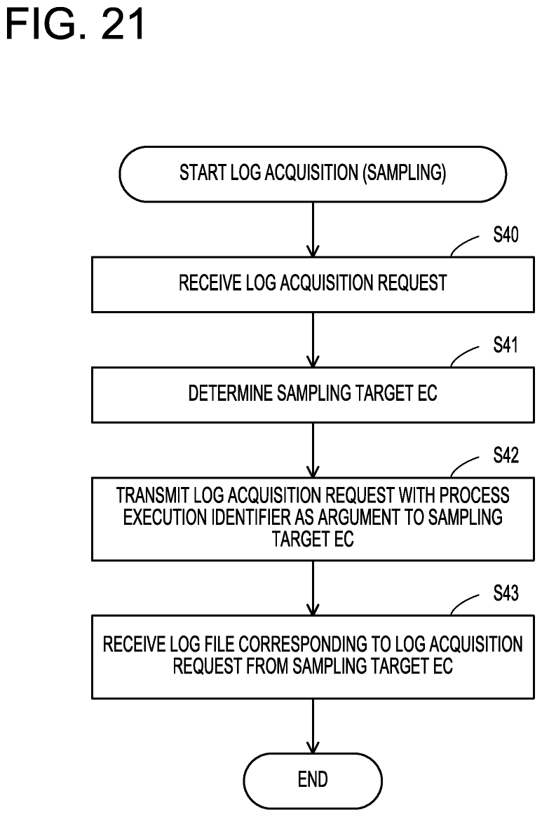

FIG. 21 is a flowchart illustrating an example of the log acquisition (sampling).

A log acquisition (sampling) process corresponds to operation S30.

(S40) The log acquisition unit 132 receives a log acquisition request from the client 400. The log acquisition request is a request for acquisition of a log file excluding a variable part. The log acquisition request includes a process execution identifier (“exec_id”) of a log file acquisition target.

(S41) Based on the information stored in the storage unit 120 in operation S15, the log acquisition unit 132 specifies a plurality of ECs that provides a program corresponding to the process execution identifier, and determines a sampling target EC among the plurality of ECs. When an EC cluster has not been created, the log acquisition unit 132 randomly selects a predetermined number (two or more) of ECs from the plurality of ECs and sets the predetermined number of ECs as sampling targets. When an EC cluster has been created, the log acquisition unit 132 may determine, for example, based on the cluster, a predetermined number of sampling targets from ECs that belong to different clusters, one by one from each cluster. A result of the clustering is used to increase the possibility of extracting a variable part with as few samples as possible.

(S42) The log acquisition unit 132 transmits a log acquisition request with the designated process execution identifier as an argument to the sampling target EC.

(S43) The log acquisition unit 132 receives a log file corresponding to the log acquisition request transmitted in operation S42 from the sampling target EC. The log acquisition unit 132 stores the received log file (the process execution history entry R2 and the log data store entry R3) in the log data store 122.

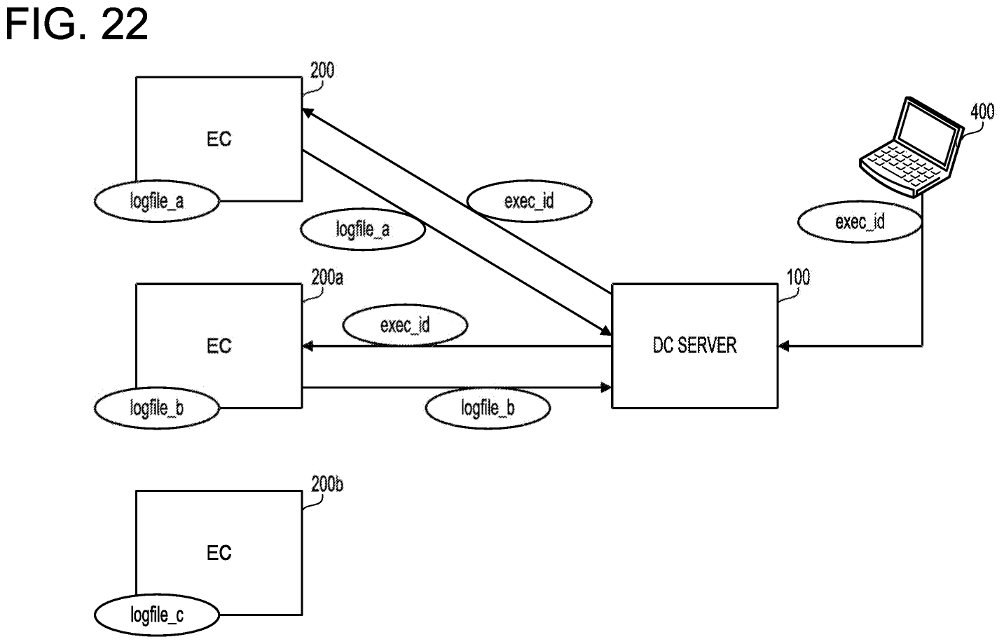

FIG. 22 is a view illustrating an example of the log acquisition (sampling).

For example, the EC 200, 200a, and 200b executes a deployed program to generate a log file. The EC 200 holds a log file “logfile_a” in association with a process execution identifier “exec_id”. The EC 200a holds a log file “logfile_b” in association with the process execution identifier “exec_id”. The EC 200b holds a log file “logfile_c” in association with the process execution identifier “exec_id”. The ECs 200, 200a, and 200b hold the respective log files in association with common process execution identifier.

The DC server 100 receives a log acquisition request including the process execution identifier “exec_id” from the client 400. Then, the DC server 100 specifies the ECs 200, 200a, and 200b that deploy a program corresponding to the process execution identifier “exec_id”. The DC server 100 selects a sampling target EC from the ECs 200, 200a, and 200b. For example, the DC server 100 selects the EC 200 and 200a as the sampling target among the ECs 200, 200a, and 200b. Then, the DC server 100 transmits the log acquisition request including the process identifier “exec_id” to the ECs 200 and 200a.

Upon receiving the log acquisition request, the EC 200 transmits a log file “logfile_a” corresponding to the process identifier “exec_id” included in the log acquisition request to the DC server 100.

Upon receiving the log acquisition request, the EC 200a transmits a log file “logfile_b” corresponding to the process identifier “exec_id” included in the log acquisition request to the DC server 100.

Thus, the DC server 100 acquires the log file from the sampling target EC.

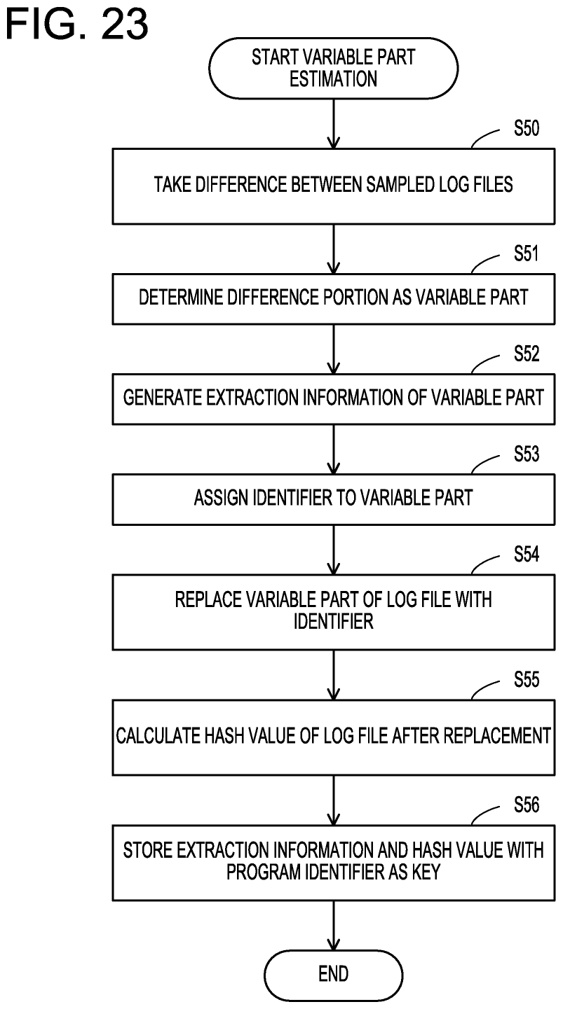

FIG. 23 is a flowchart illustrating an example of a variable part estimation.

A variable part estimation process corresponds to operation S31.

(S50) The variable part estimation unit 133 takes a difference between sampled log files. For example, the variable part estimation unit 133 may take a difference by a diff command or the like provided by the OS. As described above, the variable part estimation unit 133 takes the difference after replacing a time described portion included in each log file with a predetermined character string.

(S51) The variable part estimation part 133 determines the portion of the difference acquired by operation S50 as a variable part.

(S52) The variable part estimation unit 133 generates extraction information of the variable part determined in operation S51. The extraction information is information used for extraction of the corresponding variable part, for example, information indicating the position of the variable part in the log file by a line number, a regular expression, or the like.

(S53) The variable part estimation unit 133 assigns an identifier (“var_id”) to the corresponding variable part.

(S54) The variable part estimation unit 133 replaces a variable part of any sampled log file with an identifier corresponding to the variable part.

(S55) The variable part estimation unit 133 calculates a hash value corresponding to the replaced log file by inputting the replaced log file into a predetermined hash function. Here, the hash function used in operation S55 is shared by the DC server 100 and each EC.

(S56) The variable part estimation unit 133 stores the extraction information and the hash value in the variable part identification information DB 123 using a program identifier (“program_id”) as a key. That is, the variable part estimation unit 133 generates the variable part identification information DB entry R4 including the program identifier, the extraction information generated in operation S52, the identifier of the variable part assigned in operation S53, and the hash value calculated in operation S55. The variable part estimation unit 133 stores the variable part identification information DB entry R4 in the variable part identification information DB 123.

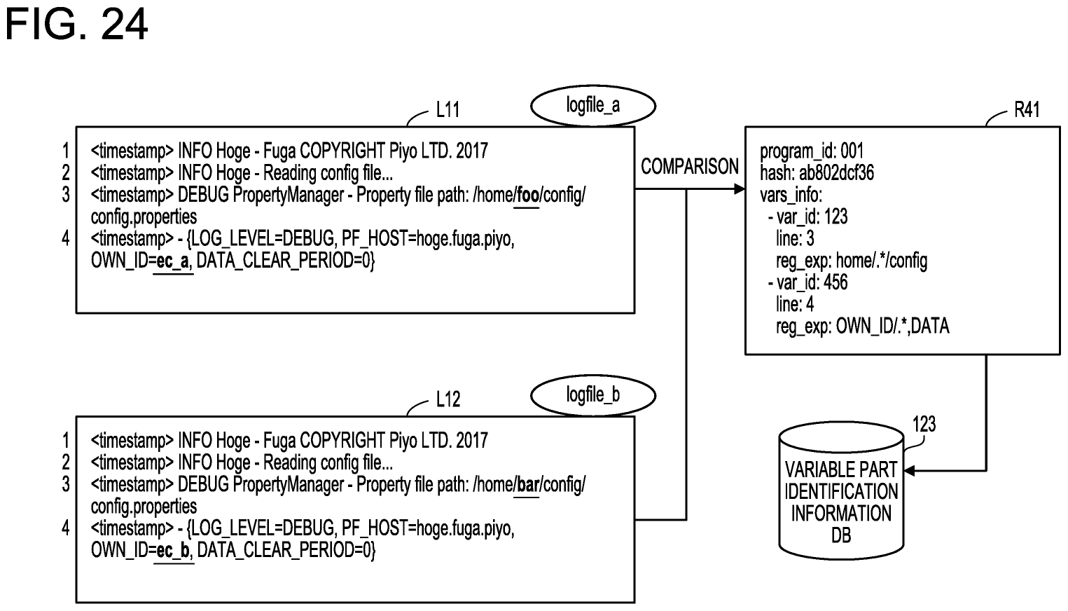

FIG. 24 is a view illustrating an example of the variable part estimation.

The log file L11 indicates the contents of a log file “logfile_a”. The log file L12 indicates the contents of a log file “logfile_b”. The variable part estimation unit 133 replaces a time described portion of each of the log files L11 and L12 with a predetermined character string before taking a difference between the log files L11 and L12. In the example of FIG. 24, the time described portion is replaced with a character string “<timestamp>”.

When comparing the log files L11 and L12, the description of “foo” on the third line of the log file L11 is different from the description of “bar” on the third line of the log file L12. Therefore, the variable part estimation unit 133 determines a difference portion corresponding to “foo” and “bar” in the log files L11 and L12 as a variable part and assigns an identifier “123” to, for example, the variable part. The variable part estimation unit 133 generates information with the line number “line: 3” and the regular expression “reg_exp: home/.*/config” as extraction information for the variable part with the identifier “123”.

Further, when comparing the log files L11 and L12, the description of “ec_a” on the fourth line of the log file L11 is different from the description of “ec_b” on the fourth line of the log file L12. Therefore, the variable part estimation unit 133 determines a difference portion corresponding to “ec_a” and “ec_b” of the log files L11 and L12 as a variable part and assigns an identifier “456” to, for example, the variable part. The variable part estimation unit 133 generates information with the line number “line: 4” and the regular expression “reg_exp: OWN_ID/.*, DATA” as extraction information for the variable part with the identifier “456”.

Further, the variable part estimation unit 133 calculates a hash value of the log file in which the variable part of the log file L11 (or log file L12) is replaced with an identifier corresponding to the corresponding variable part. The result of the calculation of the hash value is “ab802dcf36”.

The variable part estimation unit 133 generates a variable part identification information DB entry R41 in which the calculated hash value, the identifier of each variable part, and the extraction information of each variable part are registered in association with a program identifier (e.g., “001”), and stores the generated variable part identification information DB entry R41 in the variable part identification information DB 123.

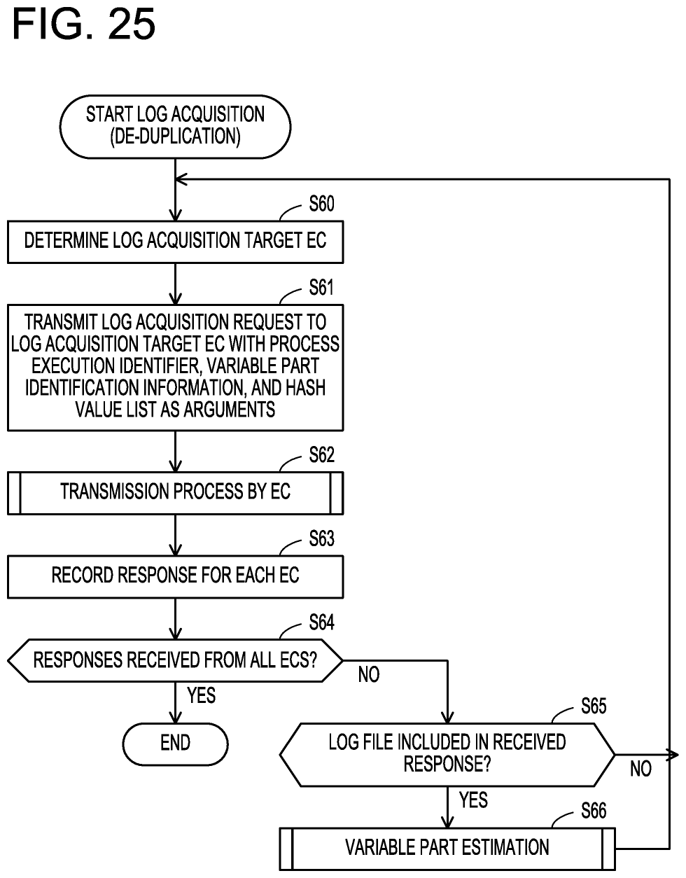

FIG. 25 is a flowchart illustrating an example of the log acquisition (de-duplication).

The log acquisition (de-duplication) corresponds to operation S32.

(S60) The log acquisition unit 132 determines a log acquisition target EC. For example, when cluster information has not been created in the cluster DB 125, the log acquisition unit 132 randomly selects a predetermined number (two or more) of ECs from ECs that have not acquired the current log file, as log acquisition target ECs. For example, when the cluster information has been created in the cluster DB 125, the log acquisition unit 132 selects a predetermined number (two or more) of ECs that have not acquired the current log file and belong to a different cluster, as log acquisition target ECs.

(S61) The log acquisition unit 132 transmits a log acquisition request to the log acquisition target EC with a process execution identifier, variable part identification information (information of the variable part identification information DB entry R4), and a hash value list as arguments. Here, in the second and subsequent “log acquisition (de-duplication)”, the log acquisition unit 132 also transmits the sum of previous hash valued to the log acquisition target EC. Therefore, it becomes a “hash value list”. The variable part identification information includes extraction information of a variable part for each hash value in the hash value list.

(S62) A log file transmission process is executed by the log acquisition target EC. Details of the log file transmission process will be described later.

(S63) The log acquisition unit 132 records a response for each log acquisition target EC. The response includes either a hash value or a log file body. That is, the log acquisition unit 132 records the response contents (a hash value or a “null” (indicating that a log file has been responded)) from each EC in an EC response recording information R6.

(S64) The log acquisition unit 132 determines whether or not responses have been received from all ECs that hold the acquisition target log files. When the responses have been received from all the ECs, the process is ended. When the responses have not been received from all the ECs, the process proceeds to operation S65.

(S65) The log acquisition unit 132 determines whether a log file is included in the current response received in operation S63. When it is determined that the log file is included in the response, the process proceeds to operation S66. When it is determined that the log file is not included in the response, the process proceeds to operation S60.

(S66) The variable part estimation unit 133 executes a variable part estimation process. In the variable part estimation in operation S66, a new variable part estimation is performed by taking a difference between the log file acquired as the response this time and a log file acquired up to the previous time. As a result, a variable part is additionally extracted. The variable part estimation procedure is as described in FIG. 23. Then, the process proceeds to operation S60.

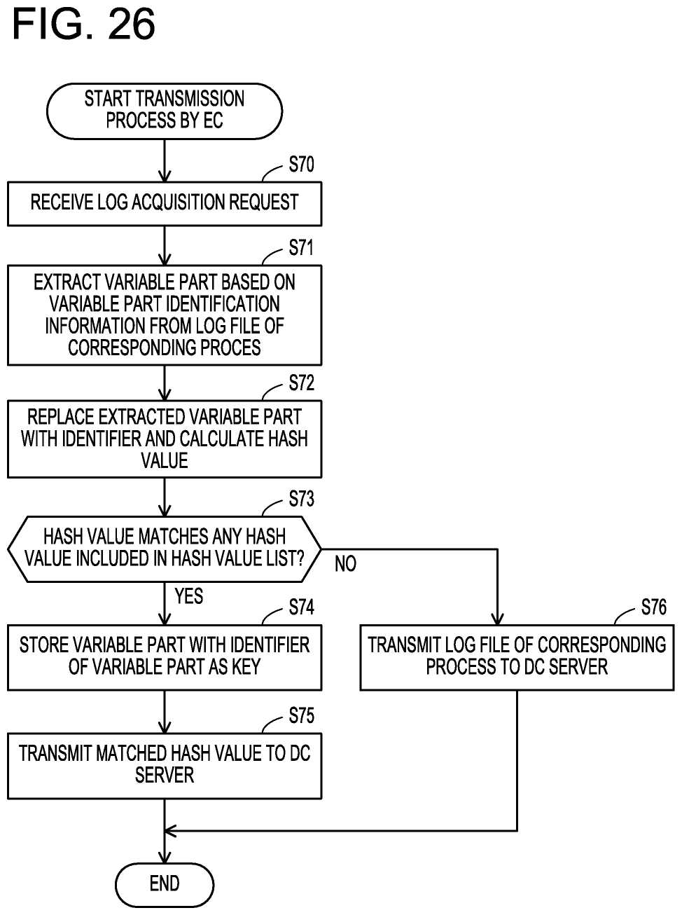

FIG. 26 is a flowchart illustrating an example of a transmission process by the EC.

The transmission process by the EC corresponds to operation S62.

(S70) The log duplication determination unit 233 receives a log acquisition request from the DC server 100. The log duplication determination unit 233 acquires a process execution identifier included in the log acquisition request, variable part identification information (variable part identification information DB entry R4), and a hash value list. The log duplication determination unit 233 stores the variable part identification information DB entry R4 in the variable part identification information DB 223.

(S71) The log duplication determination unit 233 extracts a variable part based on the variable part identification information from a log file of a process corresponding to the process execution identifier designated in the log acquisition request.

(S72) The log duplication determination unit 233 replaces the extracted variable part with an identifier corresponding to the variable part (the identifier included in the log acquisition request) and calculates a hash value of the log file after the replacement. In addition, the log duplication determination unit 233 replaces a time description included in the log file with a predetermined character string agreed in advance with the DC server 100 before calculating the hash value.

(S73) The log duplication determination unit 233 determines whether the hash value calculated in the operation S72 matches any hash value included in the hash value list. When it is determined that the hash values match, the process proceeds to operation S74. When it is determined that the hash values do not match, the process proceeds to operation S76.

(S74) The log duplication determination unit 233 stores the variable value with the identifier of the variable part as a key. That is, the log duplication determination unit 233 generates the variable part DB entry R5 and stores the generated log duplication determination unit 233 in the variable part DB 224.

(S75) The log duplication determination unit 233 transmits the matched hash value to the DC server 100. Then, the transmission process by the EC is ended.

(S76) The log duplication determination unit 233 transmits the log file of the corresponding process to the DC server 100. Then, the transmission process by the EC is ended.

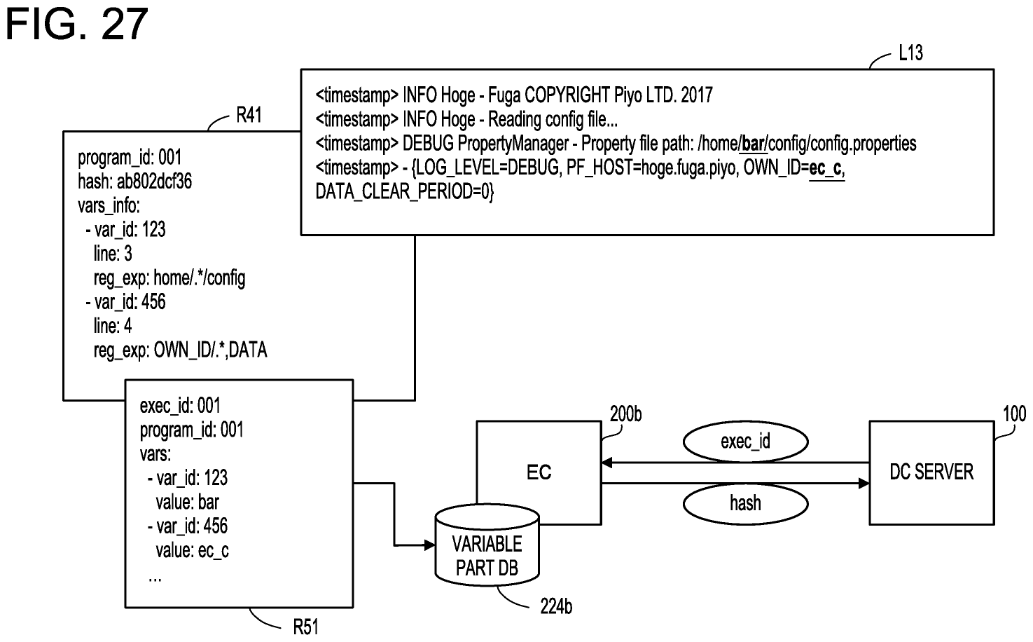

FIG. 27 is a view illustrating an example of the log acquisition (de-duplication).

The EC 200b holds a log file L13. In this case, the EC 200b receives a log acquisition request including a process execution identifier (“exec_id”) “1”, a variable part identification information DB entry R41, and a hash value (hash) “ab802dcf36” from the DC server 100. The hash value is included in the variable part identification information DB entry R41.

The EC 200b extracts a variable part from the log file L13 based on the variable part identification information DB entry R41. For example, the EC 200b extracts “bar” on the third line of the log file L13 corresponding to var_id “123” of the variable part identification information DB entry R41, as the first variable part. Further, the EC 200b extracts “ec_c” on the fourth line of the log file L13 corresponding to var_id “456” of the variable part identification information DB entry R41, as the second variable part.

The EC 200b generates a variable part DB entry R51 in which the extracted first variable part value “bar” is associated with var_id “123” and the extracted second variable part value “ec_c” is associated with var_id “456”, stores the generated variable part DB entry R51 in the variable part DB 224b of the EC 200b. The EC 200b replaces the time portion of the log file L13 with a character string “timestamp”, replaces the first variable part with “123”, replaces the second variable part with “456”, and calculates a hash value of the log file after the replacement. It is assumed that the calculated hash value is “ab802dcf36”. The calculated hash value matches the hash value “ab802dcf36 received from the DC server 100. Therefore, the EC 200b transmits the hash value “ab802dcf36” to the DC server 100.

The DC server 100 receives the hash value “ab802dcf36” from the EC 200b. Then, based on the variable part identification information DB entry R41, the DC server 100 determines that the description of the log file L13 other than the portion of the variable part indicated by “var_id” of “123” and “456” is common to the log files L11 and L12.

Further, the hash value calculated by the EC 200b may be different from the hash value received from the DC server 100. In this case, the EC 200b transmits the held log file, and not the hash value to the DC server 100.

In addition, the DC server 100 includes not only a hash value when each variable part extracted this time is replaced with an identifier but also a hash value when a portion having a high possibility of being shared is left, in the hash value list, and sends the hash value list to each EC. Thereby, the DC server 100 may partially specify a variable part by the hash value returned from the EC. As a result, the cost of separately collecting variable parts may be saved, and at the same time, the accuracy of clustering is increased by the hash value to which each edge responds, which facilitates sampling. However, this does not prevent the DC server 100 from transmitting only the hash value when each variable part extracted this time is replaced with an identifier in operation S61. That is, the DC server 100 may transmit a single hash value corresponding to the current replacement instead of the hash value list.

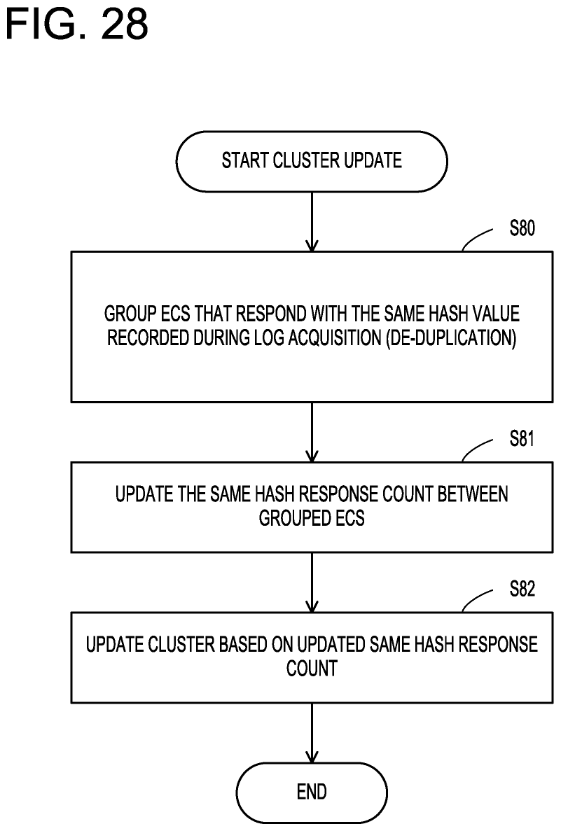

FIG. 28 is a flowchart illustrating an example of a cluster update.

A cluster update process corresponds to operation S33.

(S80) The log acquisition unit 132 groups ECs that respond with the same hash value recorded during log acquisition (de-duplication). Specifically, based on the EC response record information R6, the log acquisition unit 132 generates match information R7 by specifying and grouping EC groups that respond with the same hash value.

(S81) The log acquisition unit 132 updates the same hash response count between the grouped ECs. That is, the log acquisition unit 132 updates the same hash response count information R8 based on the match information R7.

(S82) The log acquisition unit 132 updates a cluster based on the updated same hash response count. That is, based on the same hash response count information R8, the log acquisition unit 132 registers a set of hash values having a hash response rate equal to or higher than a predetermined threshold value, as a cluster, in the cluster DB entry R9. In operation S82, when there is no existing cluster in the cluster DB entry R9, a new cluster is registered. When there is an existing cluster in the cluster DB entry R9, the existing cluster is updated. In addition, a threshold value in operation S82 is preset in the storage unit 120. As for the threshold value, for example, a value according to operation such as 70% or 80% is set.

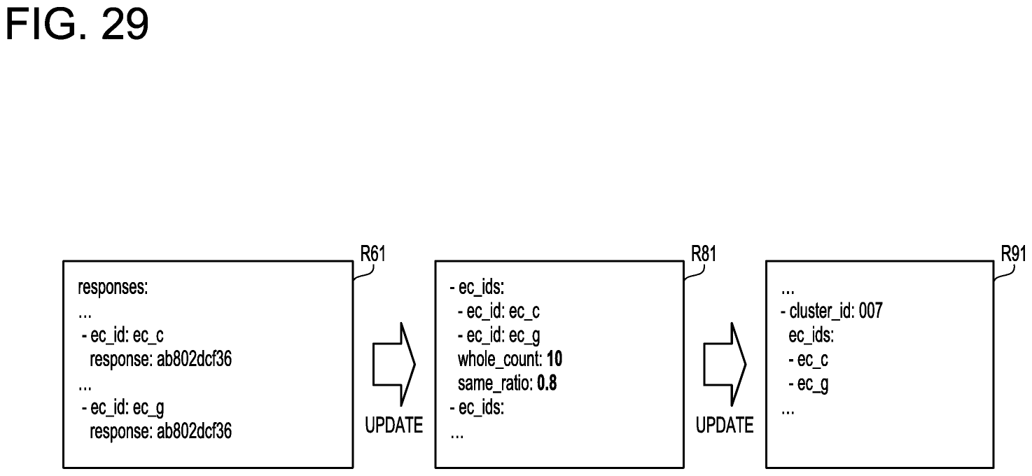

FIG. 29 is a view illustrating an example of the cluster update.

It is assumed that the DC server 100 holds EC response record information R61. A hash value “ab802dcf36” is recorded for EC identifiers “ec_c” and “ec_g” in the EC response recording information R61. This indicates that two ECs corresponding to the EC identifiers “ec_c” and “ec_g” respond with the same hash value.

The DC server 100 generates match information R7 based on the EC response record information R61 and generates same hash response count information R81 based on the match information R7. The same hash response count information R81 includes information such as “whole count” of “10” and “same_ratio” of “0.8” for a set of EC identifiers “ec_c” and “ec_g”. This indicates that the total number of responses of the two ECs corresponding to the EC identifiers “ec_c” and “ec_g” with the same hash value is 10 and the probability that the two ECs respond with the same hash value is 0.8=80%. It is assumed that the probability is larger than a threshold value of the probability for clustering.

Then, the DC server 100 generates a cluster DB entry R91 indicating that the two ECs corresponding to the EC identifiers “ec_c” and “ec_g” are clustered, and stores the generated cluster DB entry R91 in the cluster DB 125. The example of the cluster DB entry R91 represents that the two ECs corresponding to the EC identifiers “ec_c” and “ec_gV belong to a cluster having a cluster identifier (“cluster_id”) “007”.

In this way, the DC server 100 transmits variable part extraction information, a variable part identifier, and a hash value to two or more ECs and records a combination ((i.e., cluster) of ECs that responds with the transmitted hash value in the cluster DB125. In performing the log acquisition (sampling) from each EC, when a plurality of EC combinations that responds with a common hash value in the past is recorded, the DC server 100 acquires log files from ECs that belong to different combinations.

Thus, the DC server 100 may extract a relatively large number of variable parts with a small number of samplings by clustering ECs and performing the log acquisition (sampling) in FIG. 21. For this reason, the sampling load for variable part extraction may be reduced. Further, in the log acquisition (de-duplication), the possibility that a hash value is responded from each EC increases and the possibility that the log file body is responded decreases. For this reason, the communication load accompanying the log acquisition may be further reduced.

The DC server 100 may acquire a value of a variable part (variable value) in a log file held by an EC that responds with a hash value. Next, the variable value acquisition procedure by the DC server 100 will be exemplified.

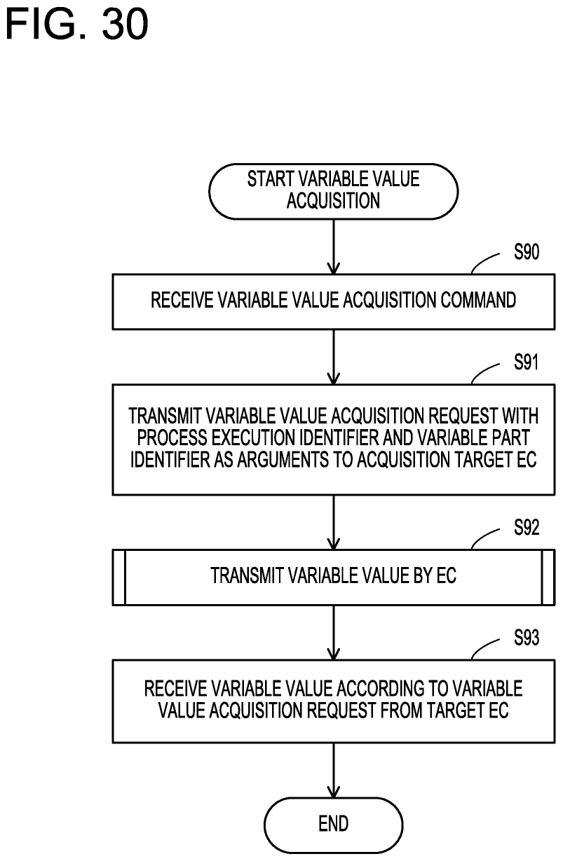

FIG. 30 is a flowchart illustrating an example of a variable value acquisition.

(S90) The log acquisition unit 132 receives a variable value acquisition command from the client 400.

(S91) The log acquisition unit 132 specifies an acquisition target EC based on the received variable value acquisition command. The acquisition target EC is an EC that has not yet acquired a designated variable value from the client 400. The log acquisition unit 132 transmits a variable value acquisition request with a process execution identifier and a variable part identifier as arguments to the acquisition target EC.

(S92) The variable value transmission process by the EC is executed in response to the variable value acquisition request transmitted by the DC server 100. Details of the variable value transmission process by the EC will be described later.

(S93) The log acquisition unit 132 receives a variable value according to the variable value acquisition request from the target EC. The log acquisition unit 132 generates a variable part DB entry R5 based on the received variable value and stores the variable part DB entry R5 in the variable part DB 124. The log acquisition unit 132 transmits the variable value of the designated variable part to the client 400 via the CL communication unit 140.

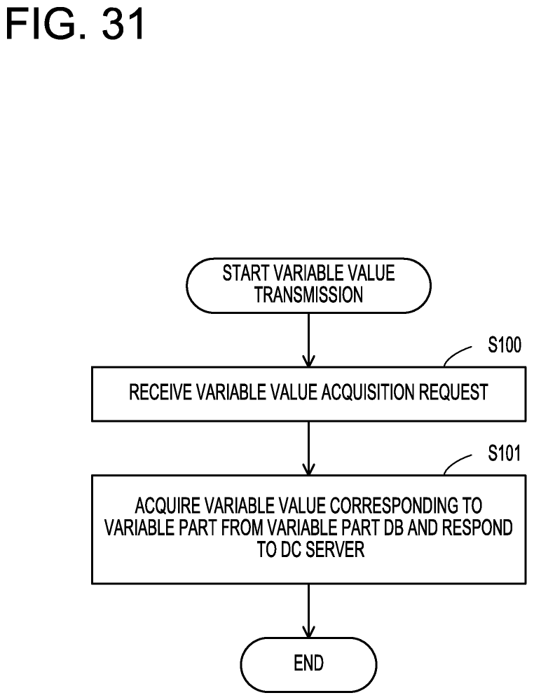

FIG. 31 is a flowchart illustrating an example of a variable value transmission.

The variable value transmission process corresponds to operation S92.

(S100) The variable search unit 234 receives a variable value acquisition request from the DC server 100.

(S101) The variable search unit 234 acquires a variable value corresponding to a variable part indicated by a process execution identifier and a variable part identifier included in the variable value acquisition request from the variable part DB 224. The variable search unit 234 transmits the acquired variable value to the DC server 100.

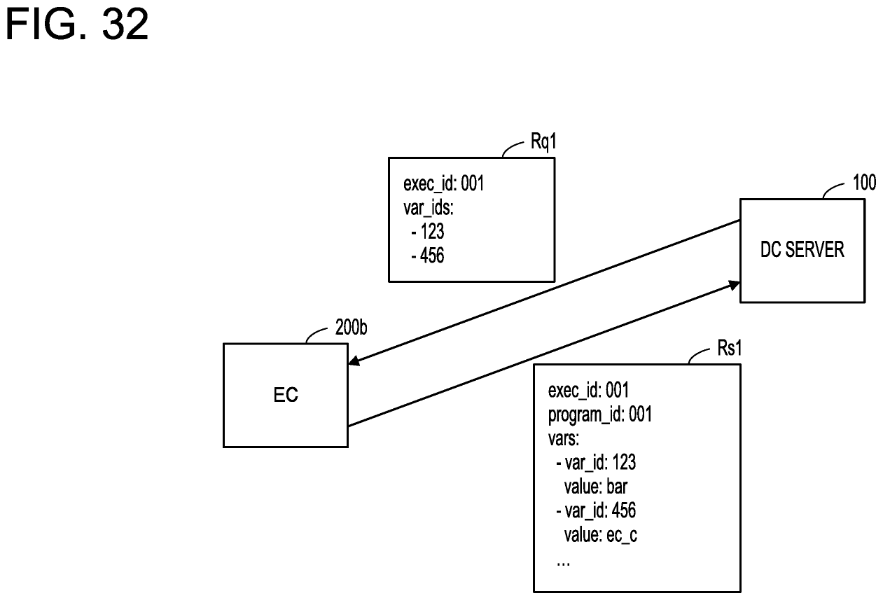

FIG. 32 is a view illustrating an example of a variable value acquisition.

For example, the DC server 100 transmits, to the EC 200b, a variable value acquisition request Rq1 with a process execution identifier “001” and variable part identifiers “123” and “456” as arguments.

Upon receiving the variable value acquisition request Rq1, the EC 200b searches the variable part DB 224b using the process execution identifier “001” and the variable part identifier “123” as keys to acquire a variable value “bar” corresponding to the keys. Further, the EC 200b searches the variable part DB 224b using the process execution identifier “001” and the variable part identifier “456” as keys to acquire a variable value “ec_c” corresponding to the keys.

Then, for example, the EC 200b transmits, to the DC server 100, a response Rs1 including the process execution identifier “001”, the program identifier “001”, the variable value “bar” for the variable part identifier “123”, and the variable value “ec_c” for the variable part identifier “456”.

Thus, the DC server 100 may acquire a variable value of a variable part afterwards even for an EC that responds with a hash value in the log acquisition stage.

When the DC server 100 collects logs from a large number of ECs, the communication load accompanying the log collection may increase depending on a collection method. For example, there may be a small amount of duplicate contents in a generated log in EC units. In this case, for example, even when a duplicate portion of the transmitted contents is detected in each EC before the log is transmitted and a de-duplication is performed, the effect of reducing the communication load of the log collection by the DC server 100 is small. That is, the main factor of the communication load accompanying the log collection is transmission of the log body from a large number of ECs. Further, a log pattern in each EC is not fixed, and a dictionary (hash value) thereof may not be created simply. This is because the life cycle of a data processing program is short and new programs are created and executed one after another.

In contrast, according to the information processing system of the second embodiment, the collection of log files that are different only in variable parts and common to main message portions (such as process activation and operation status) may be suppressed, which allows the collection target to be narrowed to log files having different message portions. For example, for ECs that are operating normally and have the same main log file message, the log file itself may be omitted and only a hash value may be acquired. Therefore, only a log file that contains a message such as an error different from normal ones may be acquired. The hash value size is smaller than the log file size. For this reason, the amount of data transmitted to the network 60 is reduced. Further, the data transmission amount by each EC and the data reception amount by the DC server 100 are reduced. Thus, the communication load in the log collection may be reduced.

In addition, the DC server 100 may determine that, for an EC that has transmitted a hash value, only variable parts of log files held by the EC differ from each other and the other portions are common to the log files of other sampled ECs.

In addition, when a certain EC responds with a hash value, the DC server 100 may also acquire information on the variable part of a log file generated by the EC. Even in this case, it is only necessary to transmit data having a smaller size than when the entire log file held by the EC is transmitted to the DC server 100, thereby the communication load is reduced.

Further, the information processing according to the first embodiment may be implemented by causing the processing unit 12 to execute a program. In addition, the information processing according to the second embodiment may be implemented by causing the CPU 101 to execute a program. The program may be recorded on a computer-readable recording medium 113.

For example, the program may be distributed by distributing the recording medium 113 in which the program is recorded. Alternatively, the program may be stored in another computer and distributed via a network. For example, a computer may store (install) a program recorded in the recording medium 113 or a program received from another computer in a storage device such as the RAM 102 or the HDD 103, and read out and execute the program from the storage device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
an information processing apparatus configured to include:
a first memory; and
a first processor coupled to the first memory and the first processor configured to:
acquire log information from each of a predetermined number of log acquisition target apparatuses among a plurality of log acquisition target apparatuses, each of the plurality of log acquisition target apparatuses generating the log information;
extract a difference portion between the acquired predetermined number of log information as a variable part;
replace the extracted variable part with an identifier in the log information;
calculate a first hash value of the replaced log information; and
transmit extraction information to be used for extraction of the variable part in the log information, the identifier, and the first hash value to a log acquisition target apparatus of the plurality of log acquisition target apparatuses different from the predetermined number of log acquisition target apparatuses; and
a log acquisition target apparatus of the plurality of log acquisition target apparatuses configured to include:
a second memory; and
a second processor coupled to the second memory and the second processor configured to:
receive the extraction information, the identifier, and the first hash value;
extract the variable part from the log information generated in the log acquisition target apparatus, based on the extraction information;
replace the variable part of the generated log information with the identifier;
calculate a second hash value of the replaced log information;
determine whether or not the second hash value matches the first hash value;
transmit the first hash value to the information processing apparatus when determined that the second hash value matches the first hash value; and
transmit the log information to the information processing apparatus when determined that the second hash value does not match the first hash value.

2. The information processing system according to claim 1,
wherein the information processing apparatus transmits the identifier to the log acquisition target apparatus that has responded with the first hash value and has not acquired a value of the variable part included in the log information, and
wherein, upon receiving the identifier, the log acquisition target apparatus transmits a value of the variable part corresponding to the identifier in the generated log information to the information processing apparatus.

3. The information processing system according to claim 1,
wherein the information processing apparatus causes the plurality of log acquisition target apparatuses to execute a common program, and
wherein each of the plurality of log acquisition target apparatuses generates the log information according to execution of the common program.

4. The information processing system according to claim 1,
wherein the information processing apparatus:
transmits the extraction information, the identifier, and the first hash value to two or more log acquisition target apparatuses, and
records a combination of log acquisition target apparatuses which respond with the first hash value.

5. The information processing system according to claim 4,
wherein, when the information processing apparatus acquires the log information from each of the predetermined number of log acquisition object apparatuses, and when there is a plurality of recorded combinations of log acquisition target apparatuses which responds with a common hash value in the past, the information processing apparatus acquires the log information from the log acquisition target apparatuses that belong to different combinations each other.

6. An information processing apparatus comprising:
a memory configured in which log information acquired from a plurality of log acquisition target apparatuses are stored; and
a processor coupled to the memory and the processor configured to:
acquire log information from each of a predetermined number of first log acquisition target apparatuses;
store the acquired log information in the memory;
extract a difference portion between the acquired predetermined number of log information as a variable part;
replace the extracted variable part with the identifier in the log information;
calculate a first hash value of the replaced log information;
transmit extraction information to be used for extraction of the variable part in the log information, the identifier, and the first hash value to a second log acquisition target apparatus different from the first log acquisition target apparatuses; and
receive one of the first hash value and the log information as a response of the transmission from the second log acquisition target apparatus.

7. The information processing apparatus according to claim 6,
wherein the processor is configured to:
transmit the identifier to the second log acquisition target apparatus that has responded with the first hash value and has not acquired a value of the variable part included in the log information, and
receive, from the second log acquisition target apparatus, a value of the variable part corresponding to the identifier in the log information generated in the second log acquisition target apparatus.

8. The information processing apparatus according to claim 6,
wherein the processor is configured to cause the plurality of log acquisition target apparatuses to execute a common program and generate the log information according to execution of the common program.

9. The information processing apparatus according to claim 6,
wherein the processor is configured to:
transmit the extraction information, the identifier, and the first hash value to two or more log acquisition target apparatuses, and
record a combination of log acquisition target apparatuses which respond with the first hash value.

10. The information processing apparatus according to claim 9,
wherein, when the processor acquires the log information from each of the predetermined number of log acquisition object apparatuses, and when there is a plurality of recorded combinations of log acquisition target apparatuses which responds with a common hash value in the past, the processor is configured to acquire the log information from the log acquisition target apparatuses that belong to different combinations each other.

11. An information processing apparatus comprising:
a memory configured in which log information is stored; and
a processor coupled to the memory and the processor configured to:
receive extraction information to be used for extraction of a variable part in the log information, an identifier in the log information, and a first hash value from another information processing apparatus;
extract the variable part from the log information, based on the extraction information;
calculate a second hash value of the log information with which the variable part of the log information is replaced;
determine whether or not the second hash value matches the first hash value;
transmit the first hash value to the another information processing apparatus when determined that the second hash value matches the first hash value; and
transmit the log information to the another information processing apparatus when determined that the second hash value does not match the first hash value.
